(19) United States
(12) Patent Application Publication
(10) Pub. No.: US 2006/0153054 A1
(43) Pub. Date: Jul. 13, 2006

(54) Optical disk and optical disk manufacturing method and device

(75) Inventors: Hideo Kobayashi, Tokyo (JP); Takayuki Suzuki, Yachiyo-shi (JP); Masahiro Nakamura, Saitama-shi (JP); Naoto Ozawa, Tokyo (JP)

Correspondence Address: KOLISCH HARTWELL, P.C., 200 PACIFIC BUILDING, 520 SW YAMHILL STREET, PORTLAND, OR, 97204, US

(73) Assignee: Origin Electric Company, Limited

(21) Appl. No.: 11/325,384

(22) Filed: Jan. 3, 2006

(30) Foreign Application Priority Data
Jan. 7, 2005 (JP) 2005-002349

(51) Int. Cl. G11B 7/24

(52) U.S. Cl. 369/275.1

(57) ABSTRACT

An optical disk manufacturing method including a process of toroidally supplying a first resin on one side of a first disk substrate having an aperture at the center, in a region adjacent to the perimeter of the aperture; a process of rotating the first disk substrate provided with the first resin at a first rotational speed, and spreading the first resin; a process of curing the spread first resin in the surrounding vicinity of the aperture; a process of toroidally supplying a second resin that is superimposed on the first resin of the first disk substrate on which the first resin has cured, in the region adjacent to the perimeter of the aperture; a process of rotating the first disk substrate provided with the second resin at a second rotational speed, and spreading the second resin; and a process of curing the spread second resin.

### BACKGROUND OF THE INVENTION

1. Field of the Invention

The present invention relates to an optical disk and to a manufacturing method and a manufacturing apparatus of the optical disk. In particular, it relates to an optical disk where the thickness of the adhesive layer is uniform or where the thickness of the protective film is uniform when two disk substrates are joined together, and to the manufacturing method and manufacturing apparatus of the optical disk.

Priority is claimed on Japanese Patent Application No. 2005-002349, filed Jan. 7, 2005, the content of which is incorporated herein by reference.

2. Description of Related Art

Optical disks have evolved from CDs (compact disks) into DVDs (digital versatile disks) and further into next-generation DVDs, and their recording density has improved. With these optical disks, minute irregularities are formed in spiral grooves on the surface of, for example, a polycarbonate substrate, and the recorded data is read by scanning the irregularities with a laser beam. To improve recording density, a single optical disk has come to have multiple recording surfaces. This type of optical disk is manufactured by joining together two or more substrates having recording surfaces, with resin used as the adhesive agent.

In general, when joining together two or more substrates with resin used as the adhesive agent, the adhesive agent is toroidally applied in the vicinity of the central aperture of one of the substrates, high-speed rotation is conducted after superimposition onto the other substrate, the resin between the substrates is spread, the excess resin is spun off, and the thickness of the resin film is made entirely uniform. In this process, the air bubbles that have infiltrated the resin of the two substrates are also spun off, but it is difficult to make film thickness uniform when high-speed rotation is conducted in order to remove the air bubbles. A method has been proposed where the overall film thickness of the resin is adjusted by conducting high-speed rotation after the resin has been toroidally applied onto one of the substrates, curing the entirety of the spread resin, further applying resin onto this, and joining this substrate to the other substrate (see pp. 5-6 and FIG. 2 of patent document 1: Japanese Unexamined Patent Application, First Publication No. H 11-316982).

Moreover, patent literature 2 (Japanese Unexamined Patent Application, First Publication No. H11-176032) discloses a technology that provides a temporarily cured part 5 acting as a stopper on the disk substrate, and that fixes the interval of the adhesive layer (secondary cured part 6) after crimping the disk substrates.

In addition, patent literature 3 (Japanese Unexamined Patent Application, First Publication No. 2004-247015) discloses a technology that divides the process of ultraviolet ray irradiation into other stages, and that controls the thickness and adhesiveness of the ultraviolet-curing resin.

In addition, patent literature 4 (Japanese Unexamined Patent Application, First Publication No. 2001-209980) discloses a technology in which a resin in a vicinity of the central aperture is cured when an optical disc is produced by joining two substrates using a ultraviolet curing resin together.

However, in the technology disclosed in patent document 1, when resin is toroidally applied to the surrounding vicinity of the aperture formed in the central part of the substrate, and when high-speed rotation is conducted, there is a tendency for the resin to thin on the inner circumferential side of the substrate and to thicken at the periphery. In order to read the recorded data by laser beam, the thickness of the resin layer must be of the prescribed thickness and also must be uniform. Furthermore, demands pertaining to thickness control have also grown as recording density has increased.

In addition, in the technology disclosed in patent document 2, as crimping is conducted without rotating the disk substrates, there is a problem that the air bubbles that have infiltrated the resin of the two substrates remain unaltered.

In addition, in the technology disclosed in patent document 3, as the surfaces of the disk substrates are entirely irradiated with ultraviolet rays, there is a problem that occurrence of thickness irregularities in the ultraviolet-curing resin due to high-speed rotation of the disk cannot be fully suppressed.

In addition, in the technology disclosed in patent document 4, as the spreading of the resin is conducted only once and the vicinity of the central aperture is cured while spreading by rotation, there is a problem that it is difficult to control the thickness of the film.

### SUMMARY OF THE INVENTION

The object of the present invention is, therefore, to provide an optical disk where the thickness of the resin layer is of the prescribed thickness and is uniform, and to provide a manufacturing method and manufacturing apparatus of the optical disk.

A first aspect of the present invention is an optical disk manufacturing method including: a process of toroidally supplying a first resin on one side of a first disk substrate having an aperture at a center, in a region adjacent to a perimeter of said aperture; a process of rotating the first disk substrate provided with said first resin at a first rotational speed, and spreading said first resin; a process of curing said spread first resin in a surrounding vicinity of said aperture; a process of toroidally supplying a second resin that is superimposed onto said first resin of the first disk substrate on which said first resin has cured, in the region adjacent to the perimeter of said aperture; a process of rotating the first disk substrate provided with said second resin at a second rotational speed, and spreading said second resin; and a process of curing said spread second resin.

With this configuration, the first resin is cured in the surrounding vicinity of the aperture, and the second resin is supplied and cured upon being spread by high-speed rotation, with the result that the film thickness of the inner circumferential part is secured, and a resin layer of uniform thickness is formed by the first resin and the second resin.

A second aspect of the present invention is the optical disk manufacturing method according to the first aspect, further including: a process of superimposing a second disk substrate concentric with said first disk substrate onto said second resin provided on said first disk substrate.

With this configuration, one obtains a manufacturing method of an optical disk having two substrates that adhere by means of a resin layer of uniform thickness A third aspect of the present invention is the optical disk manufacturing method according to the first aspect, wherein said first resin and said second resin are ultraviolet-curing resin.

With this configuration, as the first resin and second resin consist of ultraviolet-curing resin, it is possible to easily conduct curing of the spread first resin and curing of the spread second resin in the surrounding vicinity of the aperture by irradiation with ultraviolet rays.

A fourth aspect of the present invention is the optical disk manufacturing method according to the first aspect, wherein said spread second resin is formed more thickly than said cured first resin.

With this configuration, as the second resin that is spread by high-speed rotation is thicker than the first resin that has cured in the surrounding vicinity of the aperture, the thickness of the second resin that is thinned in the surrounding vicinity of the aperture by high-speed rotation is supplemented by the first resin, and formation of a resin layer of uniform thickness is facilitated.

A fifth aspect of the present invention is the optical disk manufacturing method according to the first aspect, wherein said first rotational speed is greater than said second rotational speed.

With this configuration, the first resin is spread at a faster rotational speed, and thinly formed in a short time, and after the second resin is supplied, it is spread at a rotational speed that facilitates formation at the prescribed thickness, with the result that it is possible to shorten working time, and to facilitate the control of thickness.

A sixth aspect of the present invention is the optical disk manufacturing method according to the first aspect, wherein the process of supplying said first resin, the process of spreading said first resin, and the process of curing said spread first resin are repeated two or more times.

With this configuration, it is possible to make the thickness of the resin layer more uniform.

A seventh aspect of the present invention is an optical disk manufacturing apparatus including: a first resin supply device for toroidally supplying a first resin on one side of a first disk substrate having an aperture at a center, in a region adjacent to a perimeter of said aperture; a disk-rotating device for rotating said first disk substrate; a first resin-curing device for curing said first resin in a surrounding vicinity of said aperture; a second resin supply device for toroidally supplying a second resin on one side of the first disk substrate on which said first resin has cured, in a region adjacent to a perimeter of said aperture; and a second resin-curing device for curing said second resin.

With this configuration, the first resin is cured, the second resin is supplied, and the second resin is cured in the surrounding vicinity of the aperture, with the result that an optical disk manufacturing apparatus is obtained where the film thickness of the inner circumferential part is assured, and a resin layer of uniform thickness is formed by the first resin and the second resin. It is also acceptable that the first resin-curing device and the second resin-curing device be the same device.

An eighth aspect of the present invention is the optical disk manufacturing apparatus according to the seventh aspect, further including: a disk substrate supply device for superimposing a second disk substrate concentric with said first disk substrate onto the second resin provided on said first disk substrate.

With this configuration, one obtains an optical disk manufacturing apparatus that manufactures an optical disk having two substrates adhered by means of a resin layer of uniform thickness.

A ninth aspect of the present invention is the optical disk manufacturing apparatus according to the seventh aspect, wherein said first resin supply device and said second resin supply device are the same device.

A tenth aspect of the present invention is the optical disk manufacturing apparatus according to the seventh aspect, wherein said disk-rotating device rotates at greater rotational speed during a period after said first resin is supplied until curing occurs by said first resin-curing device than after said second resin is supplied.

With this configuration, it is possible to reduce the time in which the first resin is spread and to shorten working time, and also to obtain an optical disk manufacturing apparatus that facilitates control of the thickness of the resin layer by spreading the second resin.

An eleventh aspect of the present invention is the optical disk manufacturing apparatus according to the seventh aspect, further including a control device for controlling, wherein said control device controls: supplying said first resin to said first disk substrate; rotating the first disk substrate provided with said first resin at a first rotational speed; curing said first resin of the first disk substrate rotated at said first rotational speed by a first resin-curing device; supplying said second resin to the first disk substrate on which said first resin has cured; rotating the first disk substrate provided with said second resin at a second rotational speed; and curing the second resin of the first disk substrate rotated at said second rotational speed by a second resin-curing device.

With this configuration, a control device is provided to conduct control so that the first resin is supplied to the first disk substrate being rotated at a first low-speed rotational speed, the first disk substrate provided with the first resin is rotated at the first rotational speed, the rotational speed is subsequently decreased, the first resin of the first disk substrate that was rotated at the first rotational speed and for which the rotational speed was decreased is cured by the first resin-curing device, the second resin is supplied onto the first disk substrate on which the first resin has cured, the first disk substrate provided with the second resin is rotated at the second rotational speed, the second resin of the first disk substrate that was rotated at the second rotational speed is cured by the second resin-curing device, with the result that an optical disk manufacturing apparatus is obtained that automatically manufactures optical disks forming a resin layer of uniform thickness by the first resin and the second resin.

A twelfth aspect of the present invention is the optical disk manufacturing apparatus according to the seventh aspect, wherein said first resin-curing device comprises a film-thickness measurement unit for measuring the film thickness of said first resin on said first disk substrate, and a unit for adjusting the film thickness of said first resin based on the film thickness measured by said film-thickness measurement unit.

With this configuration, it is possible to minutely adjust the film thickness of the first resin, and to obtain a resin layer of more uniform film thickness.

A thirteenth aspect of the present invention is an optical disk manufacturing apparatus including: a first resin supply device for toroidally supplying a first resin on one side of a disk substrate having an aperture at a center, in a region adjacent to a perimeter of said aperture; a first disk-rotating device for rotating said disk substrate; a first resin-curing device for curing said first resin in a surrounding vicinity of said aperture; a second resin supply device for toroidally supplying a second resin on one side of the disk substrate on which said first resin has been cured, in a region adjacent to a perimeter of said aperture; a second disk-rotating device for rotating the disk substrate provided with said second resin; a disk transportation device for transporting said disk substrate from said first disk-rotating device to said second disk-rotating device; and a second resin-curing device for curing the second resin of the disk substrate rotated by said second disk-rotating device.

With this configuration, the first resin is cured in the surrounding vicinity of the aperture, the second resin is supplied and rotated, and the second resin is cured, with the result that an optical disk manufacturing apparatus is obtained that assures film thickness on the inner circumferential part, and that forms a resin layer of uniform thickness by the first resin layer and the second resin layer. Moreover, as two disk-rotating devices are provided consisting of the first disk-rotating device and the second disk-rotating device, processing can be conducted in parallel, and the quantity of manufactured optical disks can be increased.

A fourteenth aspect of the present invention is an optical disk including: a toroidal first layer positioned in a region near a center of a disk substrate on one side of the pertinent disk substrate; and a second layer overlaying at least part of said first layer, and covering the recording surface on said one side, wherein said first layer is formed to become at least semi-cured before said second layer is cured.

The optical disk provided with this configuration reduces errors in thickness in the adhesive layer and the like, and is well suited to the recording of high-density data and the like.

### BRIEF DESCRIPTION OF THE DRAWINGS

FIG. 1 is a sectional view of an optical disk 1 manufactured according to an optical disk manufacturing method which is one embodiment of the present invention.

FIG. 2 is a process drawing representing the optical disk manufacturing process.

FIG. 3A is a sectional view presenting a method for applying voltage in the optical disk manufacturing process, and is a view that presents a method for supplying the first resin while applying voltage.

FIG. 3B is a sectional view presenting a method for applying voltage in the optical disk manufacturing process, and is a view that presents a method for supplying the second resin while applying voltage.

FIG. 3C is a sectional view presenting a method for applying voltage in the optical disk manufacturing process, and is a view that presents a method for superimposing the second disk while applying voltage.

FIG. 4 is a graph showing the distribution of thickness and the position from the center of the substrate, when the resin layer is spread by rotation according to a conventional method and the method of the present invention.

FIG. 5 is a block diagram presenting the configuration of an optical disk manufacturing apparatus.

FIG. 6A is a block diagram presenting an example of configuration of an ultraviolet irradiation device capable of irradiating the surrounding vicinity of the central aperture only and the entirety of the disk substrate.

FIG. 6B is a block diagram presenting an example of configuration of an ultraviolet irradiation device capable of irradiating the surrounding vicinity of the central aperture only and the entirety of the disk substrate.

FIG. 7 is a block diagram presenting the configuration of an optical disk manufacturing apparatus that conducts the processing for manufacturing an optical disk at the respective locations inside the apparatus.

FIG. 8A is a block diagram presenting the configuration of an ultraviolet irradiation device for irradiating only the surrounding vicinity of the aperture.

FIG. 8B is a block diagram presenting the configuration of an ultraviolet irradiation device for irradiating only the surrounding vicinity of the aperture.

FIG. 8C is a block diagram presenting the configuration of an ultraviolet irradiation device for irradiating only the surrounding vicinity of the aperture.

FIG. 9 is a partial sectional view presenting one method for superimposing the second disk substrate 3 onto the first disk substrate 2 on top of the base, and for moving the joined first disk substrate 2 and second disk substrate 3 using a second disk substrate loading arm.

FIG. 10 is a block diagram presenting the configuration of an optical disk manufacturing apparatus that is provided with two units of devices that conduct time-consuming processing.

FIG. 11 is a flowchart presenting an optical disk manufacturing method that conducts processing in a single series.

FIG. 12 is a flowchart presenting an optical disk manufacturing method that conducts parallel processing for a portion of the processing.

FIG. 13 is a process drawing representing an optical disk manufacturing process, where resin is supplied to two disk substrates which are then joined together.

FIG. 14 is a block diagram presenting the configuration of an optical disk manufacturing apparatus, where resin is supplied to two disk substrates which are then joined together.

FIG. 15A is a sectional view of an optical disk manufactured by an optical disk manufacturing method which is an embodiment of the present invention, where resin is supplied to two disk substrates which are then joined together.

FIG. 15B is a sectional view of an optical disk manufactured by an optical disk manufacturing method which is an embodiment of the present invention, which is configured from one disk substrate.

FIG. 15C is a sectional view of an optical disk manufactured by an optical disk manufacturing method which is an embodiment of the present invention, which is manufactured by partially curing the first resin and second resin.

FIG. 16 is a block diagram showing an example of configuration of a resin-curing device.

FIG. 17 is a block diagram showing an example of configuration of a resin-curing device.

FIG. 18 is a sectional view of an optical disk 1 manufactured according to an optical disk manufacturing method which is one embodiment of the present invention.

### DETAILED DESCRIPTION OF THE INVENTION

Embodiments of the present invention are explained below with reference to drawings. In the various drawings, devices that are mutually identical or equivalent are given the same code number, and duplicative description is omitted.

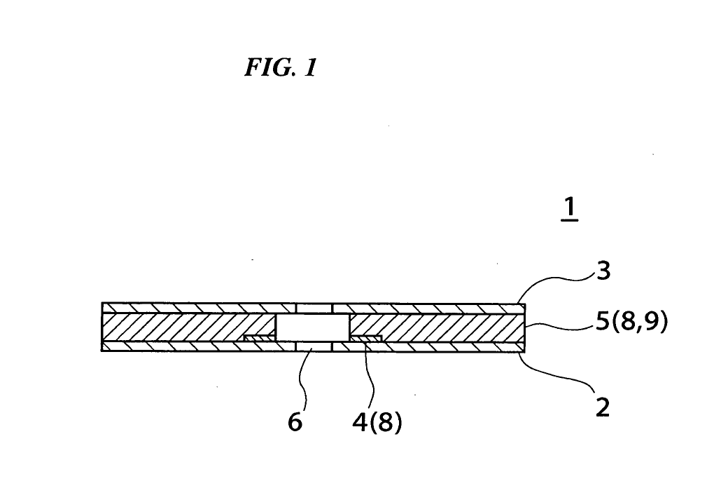

First, the configuration of the optical disk manufactured by the optical disk manufacturing method of the present invention is described with reference to FIG. 1. FIG. 1 is one example of a sectional view of an optical disk 1 manufactured by the below-described optical disk manufacturing method which is an embodiment of the present invention. The optical disk 1 is provided with the two disk substrates 2 and 3. The disk substrates 2 and 3 are typically disks made of polycarbonate resin, but the material is not limited to polycarbonate, and other materials that transmit laser beams may also be suitably used. The disk substrates 2 and 3 are thin plates, and a circular aperture 6 is formed in the center. The peripheral form is commonly circular, but it does not have to be circular. As one example, the dimensions of the disk substrates 2 and 3 may have a diameter of 120 mm, a diameter of the central aperture of 15 mm, and a thickness of 0.6 mm, but the dimensions vary according to application. Spiral grooves or minutely concave grooves forming signals are formed on the inner surface(s) of one or both (the mutually opposing surfaces) of the disk substrates 2 and 3.

The two disk substrates 2 and 3 are joined together by the adhesive layers 4 and 5. As the material of the adhesive layers 4 and 5, ultraviolet-curing resin may be suitably used, but other materials are also acceptable. FIG. 1 illustrates an enlargement of the thickness of the adhesive layers 4 and 5. Relative to disk substrates 2 and 3 with, for example, a thickness of 0.6 mm, the thickness of the adhesive layers 4 and 5 is from 15 to 100 μm, which is smaller than the thickness of the disk substrates 2 and 3. The adhesive layers 4 and 5 are configured from the resin 4 in the surrounding vicinity of the central aperture 6 on the disk substrate 2 and the other resin 5, but description thereof is omitted here, because it is presented in detail in the description of the below-mentioned manufacturing process.

The signals are read by irradiating the minute grooves formed in the two disk substrates 2 and 3 with laser beam.

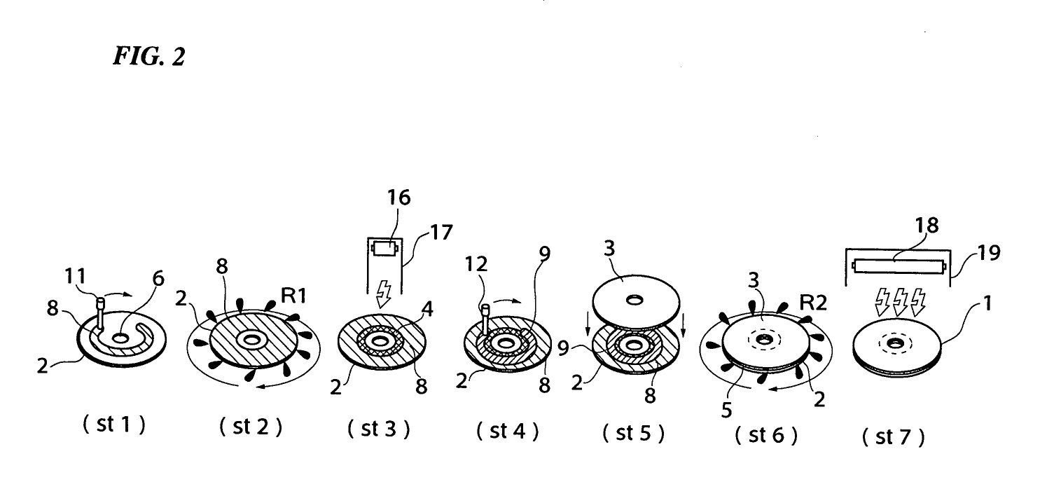

Next, the manufacturing process of the optical disk 1 which is an embodiment of the present invention is described with reference to the process drawing of FIG. 2. FIG. 2 is a process drawing representing the manufacturing process of the optical disk 1. Of the two disk substrates 2 and 3, the first disk substrate 2 is mounted onto a rotatable disk mount (not illustrated) along with being set concentric with the disk mount with the surface to be overlaid facing upward. The first disk substrate 2 is slowly rotated, and the first resin 8 is toroidally supplied (in a donut-shape) from the nozzle 11 onto the region adjacent to the perimeter of the aperture 6 of the first disk substrate 2 (St1). The toroidal shape is not necessarily continuous, and includes cases of non-continuous supply. Ultraviolet-curing resin is used as the first resin 8 for the reason that it can be cured by irradiation with ultraviolet rays, and is therefore suitable, but other resins may also be used. It is also acceptable to move the nozzle 11 in a circular manner without rotating the first disk substrate 2. The region adjacent to the perimeter of the aperture 6 is the region where the first resin 8 easily spreads toward the outside in conjunction with rotation, and covers the surface of the first disk substrate 2, when the first disk substrate 2 provided with the first resin 8 is rotated at high speed. As mentioned below, it is also the region where the resin does not drip into the aperture 6, when the second substrate 3 is superimposed on the first substrate 2 provided with resin. This region varies according to the dimensions of the disk substrate and the material of the resin (mainly its viscosity and density), but it is the region in the range of 0.75 times or less, preferably 0.6 times or less and still more preferably 0.5 times or less the radius of the first disk substrate 2 from the center, and in the range of 2.5 mm or more, preferably 5 mm or more, and still more preferably 7.5 mm or more in terms of distance from the aperture 6. For example, in the case of a disk substrate (optical disk) with an outer diameter of 120 mm and an aperture diameter of 15 mm, it is the region that is 10 to 45 mm (diameter 20 to 90 mm), preferably the region that is 12.5 to 36 mm (diameter 25 to 72 mm) and still more preferably the region that is 15 to 30 mm (diameter 30 to 60 mm) from the center. Stated in terms of the proportion relative to radius on the disk substrate, this region may be within the range of 25% to 50%.

Next, the first disk substrate 2 is rotated at a first rotational speed R1 that is a high-speed. By rotating the first disk substrate 2 at the first rotational speed R1 that is the high-speed, the toroidal first resin 8 on the first disk substrate 2 is spread toward the outside, is thinly extended, and a portion thereof is spun off from the rim. As a result, the first resin 8 covers the top surface of the first disk substrate 2 with an almost uniform thickness (St2). However, it is acceptable if the first resin 8 does not reach the vicinity of the aperture 6. As thickness varies according to the quantity of the supplied first resin 8, the material of the first resin 8 (mainly its viscosity and density), the first rotational speed R1, the rotation time and the like, it is possible to control it to the prescribed thickness. That is, the excess first resin 8 is spun off from the rim. As the film of the first resin 8 formed in this manner is thinly formed, its thickness is almost uniform, and air bubbles are not easily contained therein. In the case of, for example, an optical disk with an outer diameter of 120 mm, an aperture diameter of 15 mm and an adhesive layer thickness of 15 to 100 μm, the prescribed thickness of the film of the first resin 8 is 5 to 30 μm. It is also acceptable to reduce the supply quantity of the first resin 8, set the supply position high, and form the film of the first resin 8 in a wedge shape that thins toward the rim. In this case, the first resin 8 does not cover almost the entire top surface of the first disk substrate 2.

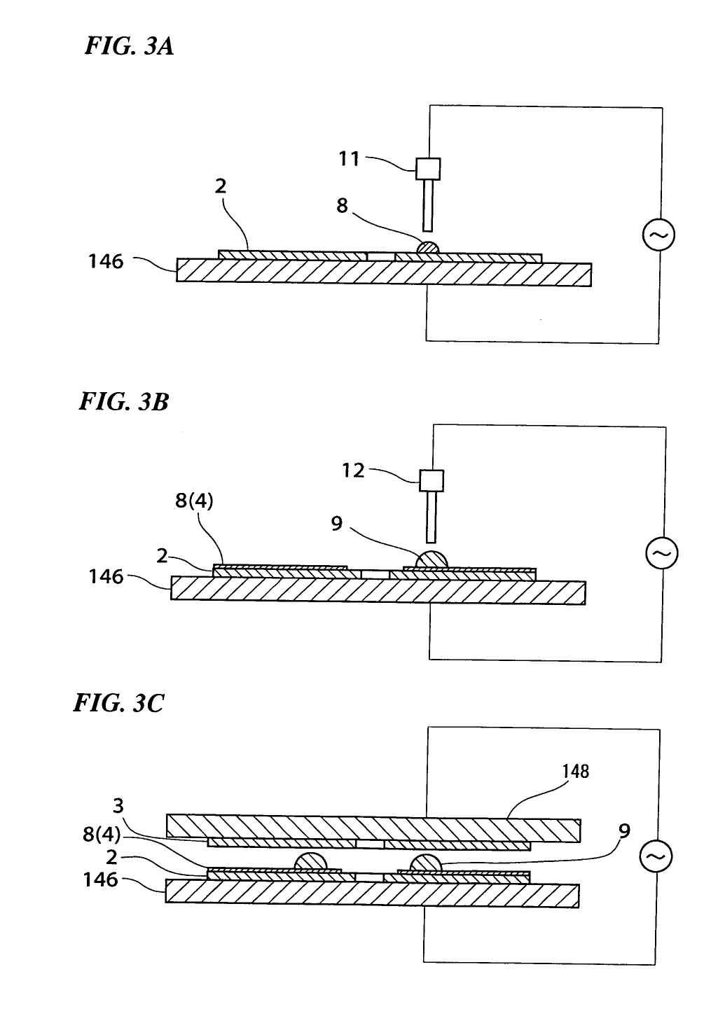

As shown in FIG. 3A, when the first resin 8 is supplied while applying voltage between the nozzle 11 and the disk mount 146, the infiltration of air bubbles can be better prevented, and this is preferable. The applied voltage may be alternating current or direct current, but it is preferable that the voltage be as low as possible in order to suppress the occurrence of electric discharge.

Returning to FIG. 2, description of the manufacturing process of the optical disk 1 continues as follows. When the film of the first resin 8 reaches the prescribed thickness, the rotational speed is decreased, rotation is finally stopped, and the film of the first resin 8 on the first disk substrate 2 is irradiated by ultraviolet rays from an ultraviolet lamp 16. It is also acceptable to move the first disk substrate 2 to a separate place to conduct the irradiation by ultraviolet rays. The ultraviolet lamp 16 is provided with a cover 17, and the ultraviolet rays only irradiate the first resin 8 in the surrounding vicinity of the aperture 6. Accordingly, only the first resin 4 in the surrounding vicinity of the aperture 6 is cured (St3). When curing only the first resin 8, it is also acceptable if it is not completely cured, and is in a semi-cured state like a gel. The range in which the first resin 8 is cured can be varied by, for example, changing the shape of the cover. As ultraviolet-curing resin is used as the first resin 8 in the present embodiment, it is easy to cure the region of one's choice as the range of irradiation by ultraviolet rays. In the case where, for example, thermosetting is used instead of ultraviolet-curing resin as the first resin 8, it is possible to cure only the surrounding vicinity of the aperture 6 by locally heating the surrounding vicinity of the aperture 6. As described below, the surrounding vicinity of the aperture 6 is here the range in which the adhesive layer tends to thin when the disk substrates 2 and 3 provided with the second resin are rotated at high speed, and the adhesive layer is formed. This range varies according to the dimensions of the disk substrate and the material of the resin (mainly its viscosity and density), but it is the range within 0.6 times, preferably within 0.5 times, and still more preferably within 0.4 times the radius of the first disk substrate 2 from the center, and may also be considered as the range that is preferably 2.5 mm or more and still more preferably 7.5 mm or more distant from the edge of the aperture. For example, in the case of a disk substrate (optical disk) with an outer diameter of 120 mm and an aperture diameter of 15 mm, it is the range of 7.5 to 36 mm (diameter 15 to 72 mm), preferably the range of 10 to 30 mm (diameter 20 to 60 mm), and still more preferably the range of 15 to 25 mm (diameter 30 to 50 mm) from the center.

Next, the first disk substrate 2 is slowly rotated, and the second resin 9 is toroidally supplied from a nozzle 12 to the region adjacent to the perimeter of the aperture 6 of the disk substrate 2 overlaying the first resin 8 (St4). It is also acceptable if the first disk substrate 2 is not rotated, and if the second resin 9 is toroidally supplied by moving the nozzle 12 in a circular manner. The material of the second resin 9 is typically of the same type as that of the first resin, but it may also be resin of different material. Ultraviolet-curing resin is suitable as the second resin 9, but other resin is also acceptable. With regard to the nozzle 12 that supplies the second resin 9, one may use the same nozzle as the first nozzle 11, but it is also acceptable to use a separate nozzle. The region to which the second resin 9 is supplied may be identical to the region to which the first resin 8 is supplied, but in the case where a greater amount is supplied compared to the first resin 8, it is preferable to provide the second resin 9 at greater distance from the aperture 6 so as to prevent the second resin 9 from dripping into the aperture 6.

Typically, the second resin 9 is provided in greater quantity than the first resin 8, and the adhesive layer is thickly formed. Furthermore, the second disk substrate 3 is frequently superimposed from above after supply of the second resin 9. Consequently, when air bubbles infiltrate the second resin 9, they are not easily discharged to the outside. For this reason, as shown in FIG. 3B, it is preferable to supply the second resin 9 while applying voltage between the nozzle 12 and the disk mount 146 in order to better prevent infiltration of air bubbles. The voltage that is applied may be alternating current or direct current, but it is preferable to set the voltage as low as possible in order to suppress the occurrence of electric discharge. The cured first resin 4 in the first resin 8 that has been supplied and spread is not illustrated in FIG. 3B.

Returning to FIG. 2, description of the manufacturing process of the optical disk 1 continues as follows. The second disk substrate 3 is concentrically superimposed on the first disk substrate 2 that has been toroidally provided with the second resin 9 (St5). The second disk substrate 3 is generally of the same material as the first disk substrate 2. The second disk substrate 3 has the same form as the first disk substrate 2, and it is as if one disk is created by concentrically superimposing it. As shown in FIG. 3C, it is preferable to superimpose the second disk substrate 3 while applying voltage between the second disk substrate 3 and the disk mount 146 so as to better prevent the infiltration of air bubbles. The voltage that is applied may be alternating current or direct current, but it is preferable to set the voltage as low as possible in order to suppress the occurrence of electric discharge. The cured first resin 4 in the first resin 8 that has been supplied and spread is not illustrated in FIG. 3C.

Returning to FIG. 2, description of the manufacturing process of the optical disk 1 continues as follows. After the second disk substrate 3 has been superimposed, the first disk substrate 2 is again rotated at a high-speed second rotational speed R2 together with the first resin 8, second resin 9 and second disk substrate 3 (St6). As a result of the high-speed rotation, the second resin 9 that was toroidally supplied to the region adjacent to the perimeter of the aperture 6 is spread toward the outer side, thinly extended, and partially spun off from the rim. However, it is acceptable if the first resin 8 does not reach the vicinity of the aperture 6. As it spreads toward the outer side, the second resin 9 mixes with the first resin 8 that has not cured. In the case where the first resin 8 and second resin 9 are of the same material, the two become integrated. The second rotational speed R2 may be identical to the first rotational speed R1, but it is also acceptable to set it slower than the first rotational speed R1 used when thinly spreading the first resin 8 so as to facilitate adjustment of the thickness of the resin layer. For example, although the first rotational speed R1 and second rotational speed R2 vary according to the material of the first resin 8 and second resin 9 and the like, they may be set from 3000 to 10000 rpm as one example.

When the second rotational speed R2 is set to high speed, it is possible to eliminate the air bubbles contained in the second resin 9 due to the action of the large centrifugal force. It is therefore required that the second rotational speed R2 be high speed. However, as stated above, as the infiltration of air bubbles can be prevented by applying voltage when supplying the second resin 9, the second rotational speed R2 can be determined solely by the conditions for spreading, which is preferable.

The second resin 9 is here supplied in greater quantity than the first resin 8, and forms to a thickness of, for example, 10 to 70 μm. Although not conspicuous in the case where it is spread thinly like the first resin 8, when it is thickly spread by rotation, it usually tends to form thinly on the inner circumferential side and thickly on the outer circumferential side. However, as there is the cured first resin 4 in the surrounding vicinity of the aperture 6, it proportionately forms thickly on the inner circumferential side. As a result, thickness on the inner circumferential side is identical to thickness on the outer circumferential side, and the thickness of the adhesive layers 4 and 5 are approximately uniform. In other words, it is preferable to form a layer with a thickness equivalent to the thickness that is thinner on the inner circumferential side by curing the first resin 4. Moreover, it is preferable to cure and form the first resin 4 in the range equivalent to the range where it is thinner on the inner circumferential side. That is, the second resin 9 is supplied, and is spread by rotation in order to form the adhesive layer at the prescribed thickness, and the first resin 8 is spread to a thickness equivalent to the thickness that is thinner on the inner circumferential side, and the first resin 4 is cured in the range where it is thinner.

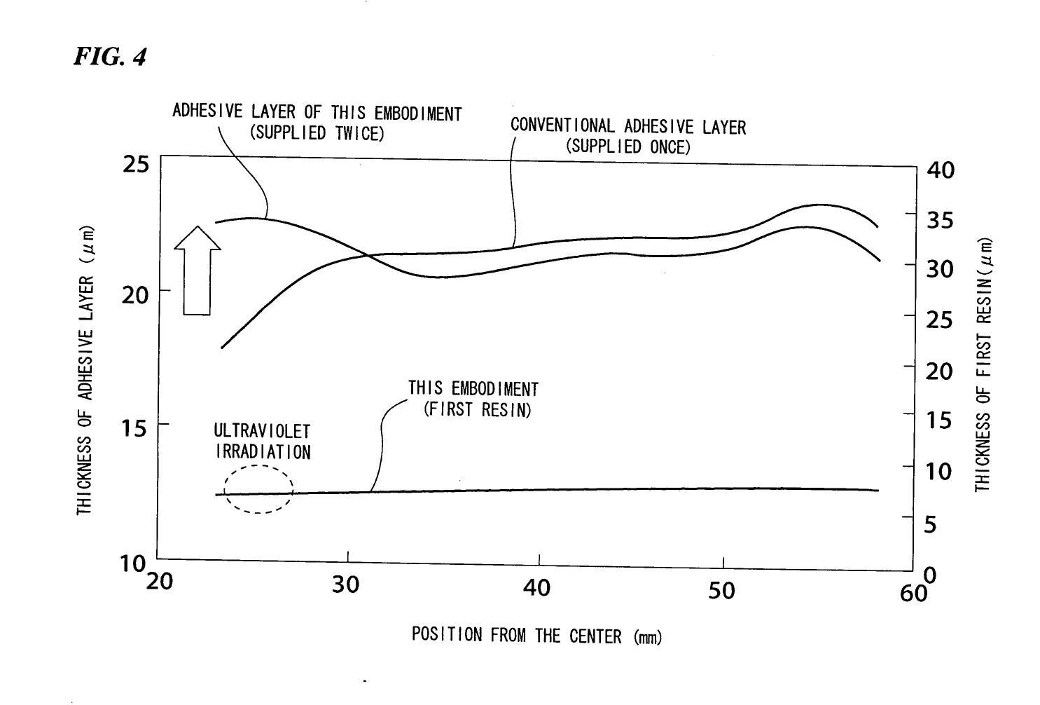

A specific example is shown in FIG. 4. FIG. 4 is a graph showing the distribution of thickness and position from the center of the disk substrate when the resin layer (adhesive layer) is spread by rotation to a thickness of approximately 20 to 25 μm according to the conventional method and the method of the present embodiment. Position (mm) from the center is plotted on the horizontal axis, and thickness (μm) is plotted on the vertical axis. The right side of the vertical axis shows a scale for the thickness of the first resin of the present embodiment, and the left side of the vertical axis shows a scale for the thickness of the entire adhesive layer. In the case of the conventional method where all the resin is supplied once on the first disk substrate, and the resin layer is spread by high-speed rotation to a thickness of approximately 20 to 25 μm, film thickness is thinner within a position that is approximately 28 mm from the center. On the other hand, with the present embodiment where a second resin layer is supplied and spread on a first resin layer that has been spread to 7 μm and cured by irradiation with ultraviolet rays in the region approximately 25 mm from the center, film thickness on the inner circumferential side (the so-called surrounding vicinity of the aperture) is increased, and thickness is almost uniform. In the vicinity of the boundary of the region irradiated with ultraviolet rays and the region not irradiated, as the first resin is in a gel-like state, and as its contribution to increased film thickness is gradually reduced, one may infer that in all likelihood film thickness smoothly changes.

The thickness of the adhesive layer varies according to the quantity and material (mainly its viscosity and density) of the supplied first resin 8 and second resin 9, the second rotational speed R2, the rotation time and so on, with the result that it is possible to control the adhesive layer at the prescribed thickness. That is, the excess second resin 9 (also containing first resin 8) is spun off from the rim. The prescribed thickness of the adhesive layer is set to 15 to 100 μm in the case of, for example, an optical disk with an outer diameter of 120 mm and an aperture diameter of 15 mm, and in this case it is possible to keep the variation in film thickness (the variation between the maximum value and the minimum value) within 3 to 5 μm.

Returning to FIG. 2, description of the manufacturing process of the optical disk 1 continues as follows. When the thickness of the adhesive layer attains the prescribed thickness, the rotational speed is decreased, rotation is finally stopped, the entire resin layer is irradiated by ultraviolet rays from above the second disk substrate 3, and the entire adhesive layer is cured (St7). The two disk substrates 2 and 3 are joined by the curing of the resin layer, and produce one optical disk 1.

As the thickness of the resin layer is approximately uniform in the optical disk 1, it is possible to prevent errors in reading the recorded data. Accordingly, the an optical disk is suited to uses involving increased recording density. In addition, it is possible to attain the prescribed thickness by adjusting the second rotational speed R2 that spreads the second resin 9 and the rotation time. There are cases where the resin layer is not formed in the vicinity of the aperture 6, but the pertinent region is not used by the recorded data, and no disadvantages arise from the resin layer not being formed.

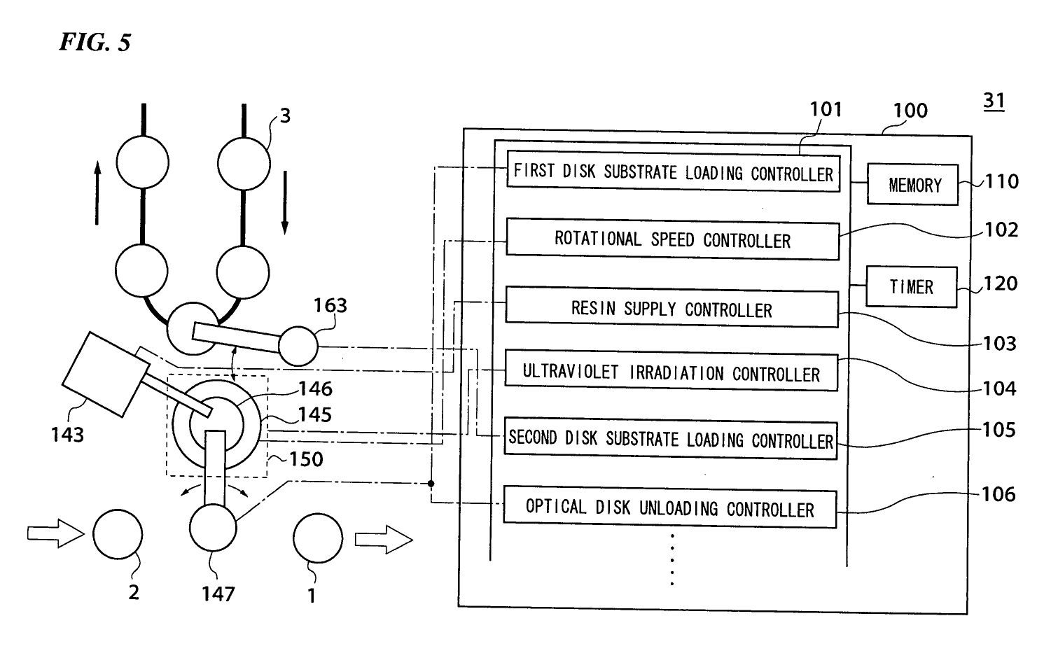

Next, an optical disk manufacturing apparatus 31 of one embodiment of the present invention is described with reference to FIG. 5. FIG. 1 and FIG. 2 are also referenced as appropriate. FIG. 5 is a block diagram presenting the configuration of the optical disk manufacturing apparatus 31. The optical disk manufacturing apparatus 31 is composed of a disk-rotating device 145 for rotating the first disk substrate 2, a resin supply device 143 for supplying the first resin 8 and second resin 9, an ultraviolet irradiation device 150 for conducting irradiation by ultraviolet rays that serves as the resin-curing device, a first loading arm 147 for mounting the first disk substrate 2 on the disk-rotating device 145, and for transportation of the manufactured optical disk 1, a second loading arm 163 for superimposing the second disk substrate 3 on the first disk substrate 2 on the disk-rotating device 145, and a control device 100 for controlling the operations of this equipment.

The disk-rotating device 145 is provided with a disk mount 146 (see FIG. 3A to FIG. 3C) for mounting and rotating the first disk substrate 2, and rotates the disk mount 146 according to the signals transmitted from a rotational speed controller 102 of the control device 100. That is, the disk-rotating device 145 rotates the first disk substrate mounted on the disk mount 146 as well as the first resin 8 and second resin 9 provided on it and also the second disk substrate 3. A projection (not illustrated) is disposed at the center of the disk mount 146 for engagement with the central aperture 6 of the first disk substrate 2, and for stabilizing the position of the first disk substrate 2 in the disk-rotating device 145. The disk-rotating device 145 is composed of a high-speed-rotation drive device for rotating the disk mount 146 at high speed for purposes of spreading the resin and a low-speed-rotation drive device for rotating the disk mount 146 at low speed when supplying the resin, and is well-suited to smoothly conducting both high-speed rotation and low-speed rotation.

The resin supply device 143 is provided with a container for storing the resin, a pump (not illustrated) for applying pressure to the resin and discharging it, and a nozzle. It is also acceptable to arrange the container at an elevated position and to conduct discharge of the resin by gravitational flow without having a pump. The nozzle may be provided with a flow meter (not illustrated) for measuring the flow rate in order to supply resin in the prescribed quantity, a switching valve for stopping the discharge of resin or a control valve for adjusting the flow rate of the resin, and so on. To enable the supply of resin to the disk substrate 2 in the region adjacent to the perimeter of the aperture 6 of the disk substrate 2, the nozzle is disposed with its tip oriented toward the region adjacent to the perimeter of the aperture 6. The operations of the resin supply device 143 are controlled by signals transmitted from a resin supply control unit 103 of the control device 100. In order to change the position in which the first resin 8 is supplied and the position in which the second resin 9 is supplied, it is preferable that the position of the nozzle tip be movable according to signals transmitted by the resin supply control unit 103.

If the nozzle tip is configured to move in a circular manner, it is possible to toroidally supply the resin onto the disk substrate 2 without rotating the disk substrate 2, with the result that the aforementioned low-speed-rotation drive device of the disk rotation device 145 becomes unnecessary. The disk rotation device 145 is configured so that the first resin 8 and second resin 9 are supplied by a single resin supply device 143, but it is also acceptable to provide two resin supply devices consisting of a device for supplying the first resin 8 and a device for supplying the second resin 9. When a configuration is adopted where the first resin 8 and second resin 9 are supplied by a single resin supply device 143, the configuration of the optical disk manufacturing apparatus 31 is simplified, the installation area decreases, and the weight of the apparatus is reduced. When two resin supply devices consisting of a device for supplying the first resin 8 and a device for supplying the second resin 9 are provided, control is simplified, and operation of the apparatus is made more stable.

The ultraviolet irradiation device 150 is composed of an ultraviolet lamp and a cover. The ultraviolet lamp is a lamp with a high proportion of ultraviolet radiation such as, for example, a xenon lamp or a mercury lamp. The cover blocks the ultraviolet rays from the ultraviolet lamp, and restricts the ultraviolet radiation direction so that only the prescribed area on the disk substrate 2 is irradiated. The optical disk manufacturing apparatus 31 adopts a configuration where a single ultraviolet irradiation device 150 is able to irradiate the first resin only in the surrounding vicinity of the aperture 6, and to irradiate the entire disk substrate 2. As a single ultraviolet irradiation device 150 is able to irradiate only the surrounding vicinity of the aperture 6 and the entirety of the disk substrate 2, the configuration of the optical disk manufacturing apparatus 31 is simplified, the installation area decreases, and the weight of the apparatus is reduced. It is also acceptable to provide two ultraviolet irradiation devices consisting of an ultraviolet irradiation device for irradiating only the surrounding vicinity of the aperture 6 and an ultraviolet irradiation device for irradiating the entirety of the disk substrate 2. When two ultraviolet irradiation devices are provided, control is simplified, and operation of the apparatus is made more stable. The operation of the ultraviolet irradiation device is controlled by the signals transmitted from an ultraviolet irradiation control unit 104 of the control device 100.

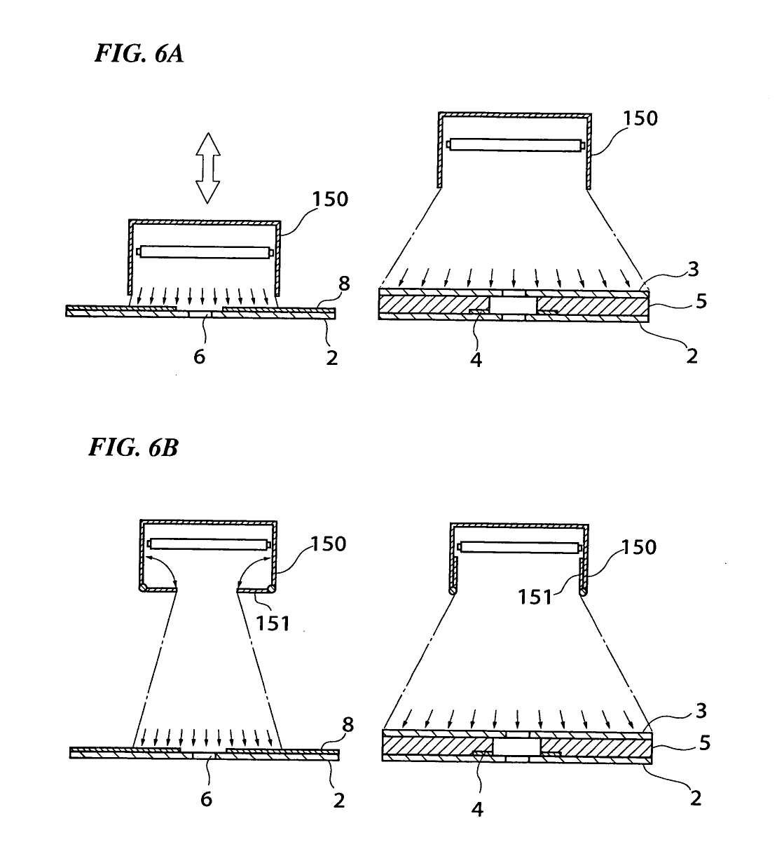

FIG. 6A and FIG. 6B show examples of configuration of the ultraviolet irradiation device 150 where only the surrounding vicinity of the aperture 6 and the entirety of the disk substrate 2 are irradiated by a single ultraviolet irradiation device 150. In the configuration example shown in FIG. 6A, only the surrounding vicinity of the aperture 6 is irradiated by bringing the ultraviolet irradiation device 150 into proximity with the disk substrate 2, and narrowing the range of irradiation from the ultraviolet irradiation device 150, while the entire disk substrate 2 is irradiated by distancing the ultraviolet irradiation device 150 from the disk substrate 2, and widening the range of irradiation from the ultraviolet irradiation device 150. That is, the range of ultraviolet irradiation is altered by the vertical movement of the ultraviolet irradiation device 150. With the configuration example shown in FIG. 6B, the opening of the underside of the cover from where the ultraviolet rays of the ultraviolet irradiation device 150 are emitted is provided with a diaphragm 151. By narrowing the opening with the diaphragm 151, only the surrounding vicinity of the aperture 6 is irradiated; by making the diaphragm 151 recede from the opening, the entire disk substrate 2 is irradiated. That is, the range of ultraviolet irradiation is altered by adjusting the diaphragm 151.

The optical disk manufacturing apparatus 31 is provided with the ultraviolet irradiation device 150 in order to cure the first resin 8 and second resin 9, but if the first resin 8 and second resin 9 are, for example, thermoset resin rather than ultraviolet-curing resin, a heating device such as, for example, an ultrasonic heater or electric heater would be provided as the resin-curing device.

Returning to FIG. 5, the description of the configuration of the optical disk manufacturing apparatus 31 continues as follows. The first loading arm 147 mounts the first disk substrate 2 to be supplied to the optical disk manufacturing apparatus 31 from, for example, the molding unit (not illustrated) that molds the first disk substrate 2 onto the disk mount 146 of the disk-rotating device 145. The first loading arm 147 mounts the first disk substrate 2 onto the disk mount 146 so that the aperture 6 of the first disk substrate 2 engages with the central projection provided in the disk mount 146. In addition, the first loading arm 147 removes the optical disk 1 assembled on the disk mount 146 from the disk mount 146, transports it from the optical disk manufacturing apparatus 31, and supplies it to an inspection device or the like on the downstream side. The first loading arm 147 is composed of: a holding part provided with claws for grasping the rim of the first disk substrate 2 or optical disk 1, or claws for lifting the first disk substrate 2 or optical disk 1 by insertion and extension of the claws in the aperture 6, or a suction port for adherence to the first disk substrate 2 or optical disk 1 by vacuum and for lifting thereof, an arm for moving the holding part to the prescribed position, and a column for supporting the holding part and arm. Its operations are controlled by signals transmitted from a first disk substrate loading controller 101 and optical disk unloading controller 106 of the control device 100.

As the second loading arm 163 has the same basic configuration as the aforementioned first loading arm 147, a duplicative description is omitted. The operations of the second loading arm 163 are controlled by signals transmitted from the second disk substrate loading controller 105 of the control device 100. The second disk substrates 3 are molded, for example, by a molding machine (not illustrated), and sequentially supplied to the second loading the second loading arm 163 from a transportation device.

The control device 100 is typically a computer, and the aforementioned first disk substrate loading controller 101, rotational speed controller 102, resin supply controller 103, ultraviolet irradiation controller 104, second disk substrate loading controller 105, optical disk unloading controller 106 and the like may consist of programs stored in the computer. The control device 100 is provided with a memory 110 for storing various types of data, a timer 120 for measuring the time, and a CPU for operating the aforementioned programs. The control device 100 is further provided with a data input unit for measuring conditions of the optical disk manufacturing apparatus 31 beginning with the rotational speed of the disk-rotating device 145 and the position of the first loading arm 147, and for intake of the measurements, and a data output unit for transmitting signals that serve to operate the various parts of the optical disk manufacturing apparatus 31. In the control device 100, the prescribed processing of the pertinent program is conducted using the inputted measurements, the time measured by the timer 120, and the various types of values stored in the memory 110, and signals for operating the various parts are outputted. The control device 100 is not limited to devices incorporated into the optical disk manufacturing apparatus 31, and may also be configured to additionally control, for example, the molding machine (not illustrated) that molds the first disk substrate 2 and second disk substrate 3, the inspection device (not illustrated) of the manufactured optical disk 1, the transportation device (not illustrated) and so on.

Next, the manufacture of the optical disk 1 by the optical disk manufacturing apparatus 31 is described. The first disk substrate 2 molded by the molding machine (not illustrated) is transported to the prescribed position of the optical disk manufacturing apparatus 31. Signals are sent from the first disk substrate loading controller 101 to the first loading arm 147, and the first loading arm 147 mounts the first disk substrate 2 onto the prescribed position of the disk mount 146 of the disk-rotating device 145. The first disk substrate 2 is here arranged at the prescribed position by engagement of the central aperture 6 of the first disk substrate 2 with the projection of the disk mount 146.

Next, signals are sent from the rotational speed controller 102 to the disk-rotating device 145, and the disk-rotating device 145 rotates the disk mount 146 at a very slow rotational speed. When this is done, signals are sent from the resin supply controller 103 to the resin supply device 143, and the resin supply device 143 toroidally supplies the first resin 8 on one side of the first disk substrate 2 in the region adjacent to the perimeter of the aperture 6. The very slow rotational speed referred to here is a rotational speed suited to the toroidal supply of the first resin 8 onto the first disk substrate 2 from the resin supply device 143, and is, for example, 30 to 120 rpm. As stated above, it is also acceptable to move the resin supply device 143 in a circular manner by signals from the resin supply controller 103, and toroidally supply the first resin 8 on one side of the first disk substrate 2 without rotation of the disk mount 146 of the disk-rotating device 145. When the first resin 8 is supplied, signals are sent from the rotational speed controller 102 to the disk-rotating device 145, and the disk-rotating device 145 rotates the disk mount 146 at a high-seed first rotational speed R1. The first disk substrate 2 rotates at high speed in conjunction with the rotation of the disk mount 146, and the first resin 8 spreads toward the outer side, covering almost all of one side of the first disk substrate 2. When the prescribed time is measured by the timer 120, signals are sent from the rotational speed controller 102 to the disk-rotating device 145, and the disk-rotating device 145 decelerates the rotation of the disk mount 146 from the first rotational speed R1 to a low speed. The prescribed time referred to here is the time in which the first resin 8 is spread to the prescribed thickness due to rotation at the first rotational speed R1.

Next, signals are sent from the ultraviolet irradiation controller 104 to the ultraviolet irradiation device 150, the surrounding vicinity of the aperture 6 of the first resin 8 on the first disk substrate 2 is irradiated with ultraviolet rays from the ultraviolet irradiation device 150, and the first resin 8 is cured in the surrounding vicinity of the aperture 6. At this time, as shown by FIG. 6A and FIG. 6B, the ultraviolet irradiation device 150 is either in close proximity to the first disk substrate 2 (see FIG. 6A), or the opening has been narrowed by the diaphragm 151 (see FIG. 6B).

Next, signals are sent from the rotational speed controller 102 to the disk-rotating device 145, and the disk-rotating device 145 rotates the disk mount 146 at a very slow rotational speed. When this is done, signals are sent from the resin supply controller 103 to the resin supply device 143, and the resin supply device 143 toroidally supplies the second resin 9 on one side of the first disk substrate 2 on which the first resin 8 is spread in the region adjacent to the perimeter of the aperture 6. The very slow rotational speed referred to here is a rotational speed suited to the toroidal supply of the second resin 9 onto the first disk substrate 2 from the resin supply device 143, and is, for example, 30 to 120 rpm. As stated above, it is also acceptable to move the resin supply device 143 in a circular manner by signals from the resin supply controller 103, and toroidally supply the second resin 9 on one side of the first disk substrate 2 without rotation of the disk mount 146 of the disk-rotating device 145.

When the second resin 9 is supplied, signals are sent from the rotational speed controller 102 to the disk-rotating device 145, and the disk-rotating device 145 temporarily stops rotating. Signals are then sent from the second disk substrate loading controller 105 to the second loading arm 163, and the second loading arm 163 superimposes the second disk substrate 3 onto the first disk substrate 2 from above the second resin 9. When this is done, signals are sent from the rotational speed controller 102 to the disk-rotating device 145, and the disk-rotating device 145 rotates the disk mount 146 at a high-speed second rotational speed R2. The first disk substrate 2, the first resin 8 and second resin 9 superimposed thereon, and the second disk substrate 3 rotate at high speed in conjunction with the rotation of the disk mount 146, and the second resin 9 is spread toward the outer side together with the first resin 8 that has not cured, and almost completely fills in between the first disk substrate 2 and second disk substrate 3. When the prescribed time is measured by the timer 120, signals are sent from the rotational speed controller 102 to the disk-rotating device 145, and the disk-rotating device 145 decelerates the rotation of the disk mount 146 from the second rotational speed R2 to a low speed. The prescribed time referred to here is the time in which the first resin 8 and second resin 9 (together constituting the adhesive layer) are spread to the prescribed thickness due to rotation at the second rotational speed R2. As the first resin 4 has cured in the surrounding vicinity of the central aperture 6, the thickness of the adhesive layer tends to be uniform.

As the first resin 8 is thinly spread on the first disk substrate 2, rotation is conducted at a particularly high speed to conduct spreading after supply of the first resin 8, but as the thickness of the resin layer 5 (the not-cured first resin 8 and second resin 9) after supply of the second resin 9 is thick, it is easier to spread than the first resin 8 alone. Thus, even if the second rotational speed R2 is slower than the first rotational speed R1, there is no major increase in working time. Accordingly, the second rotational speed R2 is set to a slower speed, which is suited to facilitating control of the thickness of the resin layer 5.

Whatever may be the prescribed time for rotation at the first rotational speed R1 or second rotational speed R2,—for example, 3 seconds or 5 seconds or 8 seconds or the like—it is usually set within a range of 2 to 15 seconds, but as it directly affects working time, a short time improves efficiency, and is therefore preferable. However, if, for example, rotational speed is raised too high due to an excessive emphasis on working time, problems arise such as that control of layer thickness becomes difficult. As the prescribed time is influenced by the material and temperature of the first resin 8 or second resin 9, it is advisable, for example, to store a prescribed time for each temperature by material in the memory 110, and to reference an appropriate prescribed time from the memory 110.

Next, signals are sent from the ultraviolet irradiation controller 104 to the ultraviolet irradiation device 150, the entire surface of the resin layer 5 (the not-cured first resin 8 and second resin 9; hereinafter the same in this paragraph) between the first disk substrate 2 and second disk substrate 3 is irradiated by ultraviolet rays from the ultraviolet irradiation device 150, and the resin layer 5 is cured. At this time, as shown in FIG. 6A and FIG. 6B, the ultraviolet irradiation device 150 is either distanced from the first disk substrate 2 (see FIG. 6A), or the diaphragm 151 is released (see FIG. 6B). The first disk substrate 2 and second disk substrate 3 are joined by the curing of the resin layer 5 to produce the optical disk 1.

Next, signals are sent from the optical disk unloading controller 106 to the first loading arm 147, and the first loading arm 147 removes the optical disk 1 from the disk-rotating device 145, and moves it to the prescribed position. The optical disk 1 that has been moved to the prescribed position is transported from the optical disk manufacturing apparatus 31, is subjected to after-treatment such as inspection, and is then shipped out as a product.

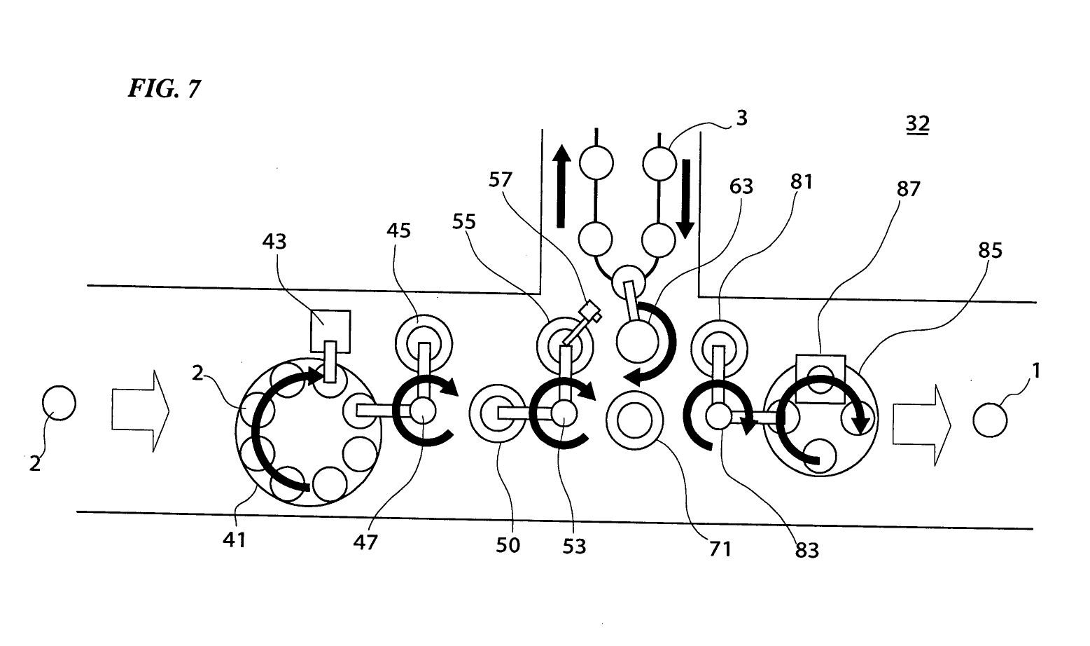

Next, with reference to FIG. 1, FIG. 2 and FIG. 7, an optical disk manufacturing apparatus 32 is described which is an embodiment of the present invention and which is different from the optical disk manufacturing apparatus 31 shown in FIG. 5. Description which is duplicative of the optical disk manufacturing apparatus 31 shown in FIG. 5 is omitted, and only the particular differences are described. FIG. 7 is a block diagram presenting the configuration of the optical disk manufacturing apparatus 32 for conducting the processing that serves to manufacture the optical disk 1 in the respective places inside the optical disk manufacturing apparatus 32. In FIG. 7, the first disk substrate 2 is supplied from the left side, is subjected to processing as it sequentially moves toward the right side, ultimately becomes the optical disk 1, and is transported away from the right side. The second disk substrate 3 is supplied from above.

The optical disk manufacturing apparatus 32 is composed of a first turntable 41 for rotationally moving the supplied first disk substrate 2 from its position of supply, passing the bottom part of the nozzle of a first resin supply device 43; toward a first moving means 47; a first rotating device 45 for conducting high-speed rotation of the first disk substrate 2 provided with the first resin 8; a first ultraviolet irradiation device 50 serving as a first resin-curing device for irradiating the first resin 8 in the surrounding vicinity of the aperture 6 with ultraviolet rays, a second resin supply device 57 for supplying the second resin 9 onto the first disk substrate 2 on which the first resin 4 has cured in the surrounding vicinity of the aperture; a base 71 for joining the first disk substrate 2 provided with the second resin 9 and the second disk substrate 3; a second disk substrate loading arm 63 for joining the second disk substrate 3 with the first disk substrate 2 mounted on the base 71; a second rotating device 81 for conducting high-speed rotation of the first disk substrate 2 joined with the second disk substrate 3, and for spreading the second resin; a second turntable 85 for moving the first disk substrate 2 and second disk substrate 3 transported from the second rotating device 81 toward the transportation side passing the second ultraviolet irradiation device 87; and a second ultraviolet irradiation device 87 serving as a second resin-curing device for conducting ultraviolet irradiation and curing of the spread second resin 9. The second resin supply device 57 is provided with a base 55 for mounting the first disk substrate 2 for purposes of supplying the second resin 9.

The optical disk manufacturing apparatus 32 is further composed of a first moving means 47 for transporting the first disk substrate 2 from the first turntable 41 to the first rotating device 45, and for transporting it from the first rotating device 45 to the first ultraviolet irradiation device 50; a second moving means 53 for transporting the first disk substrate 2 from the first ultraviolet irradiation device 50 to the base 55, and for transporting the first disk substrate 2 which is there provided with the second resin 9 to the base 71; and a third moving means 83 for transporting the joined first disk substrate 2 and second disk substrate 3 to the second rotating device 81, and for transporting the first disk substrate 2 and second disk substrate 3 subjected to high-speed rotation by the second rotating device 81 to the second turntable 85. As in the case of the optical disk manufacturing apparatus 31 (see FIG. 5), the operations of the optical disk manufacturing apparatus 32 are controlled by the controller 100 (see FIG. 5).

The first disk substrate 2 is placed on the first turntable 41, is moved by the rotation of the first turntable 41, and is sent to the bottom part of the nozzle of the first resin supply device 43. With the optical disk manufacturing apparatus 32, the nozzle of the first resin supply device 43 moves in a circular manner, and toroidally supplies the first resin 8 in the region adjacent to the perimeter of the aperture 6 of the first disk substrate 2, but it is also acceptable to provide a rotatable disk mount instead of the turntable 41, rotate the disk mount at low speed without moving the nozzle of the first resin supply device 43, and toroidally supply the first resin 8 onto the first disk substrate 2.

The first moving means 47, second moving means 53 and third moving means 83 are respectively given the same configuration as the first loading arm 147 (see FIG. 5) of the optical disk manufacturing apparatus 31, but it is also acceptable if, for example, the second moving means 53 is a turntable.

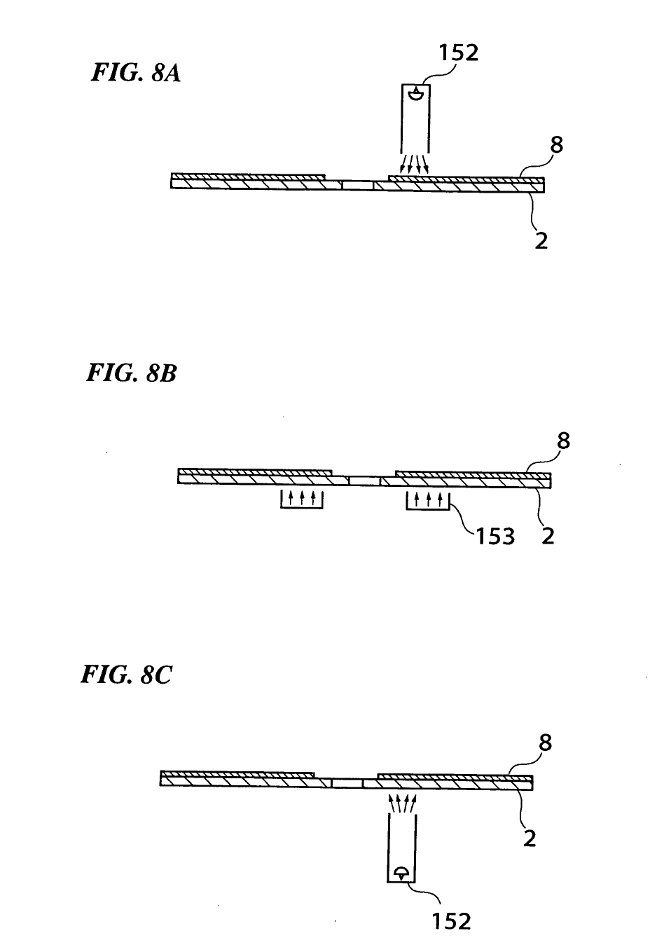

The block diagrams of the ultraviolet irradiation device of FIG. 8A to FIG. 8C illustrate ultraviolet irradiation devices that irradiate only the surrounding vicinity of the aperture 6. That is, as the first ultraviolet irradiation device 50 shown in FIG. 7 is an ultraviolet irradiation device that only irradiates the surrounding vicinity of the aperture 5, it is acceptable to have an ultraviolet irradiation device (see FIG. 8A) that conducts irradiation with spot-like ultraviolet rays and to conduct the irradiation with spot-like ultraviolet rays by means of optical fiber. Alternatively, an ultraviolet irradiation device 153 that conducts ultraviolet irradiation by means of light-emitting diodes arranged on the bottom of the first disk substrate 2 is also acceptable (see FIG. 8B). In this case, it is advisable to incorporate the light source into the disk mount. Heretofore, the ultraviolet rays irradiated the first resin 8 on the second disk substrate 2 from above, but as shown in FIG. 8B, it is also acceptable to have the irradiation transmitted through the first disk substrate 2 from below. That is, as shown in FIG. 8C, it is also possible to arrange the ultraviolet lamp 152 underneath the first disk substrate 2. In FIG. 8A to FIG. 8C, it is also acceptable to have the spot ultraviolet irradiation device 152 rotate about an axis at the center of the first disk substrate 2.

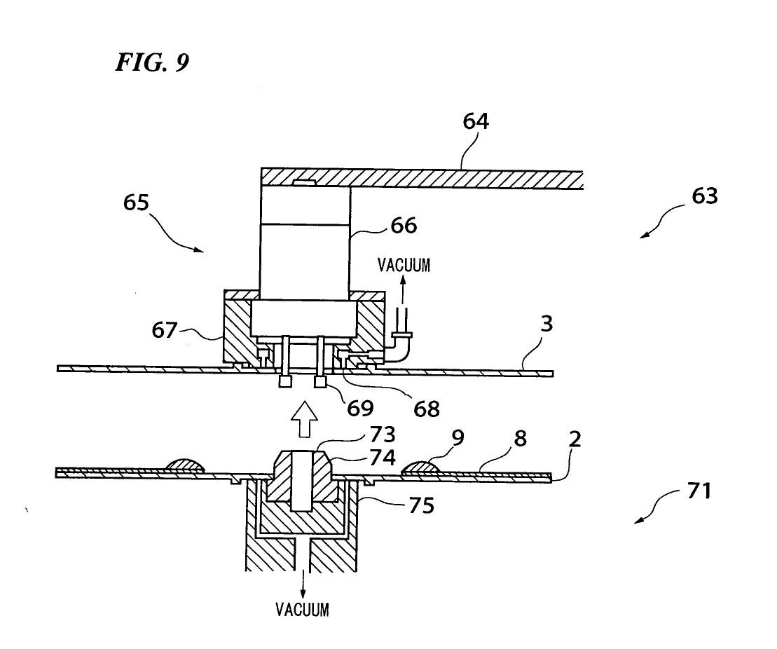

Next, a method of joining the first disk substrate 2 and second disk substrate 3 on the base 71 using the second disk substrate loading arm 63 is described with reference to FIG. 9. FIG. 9 is a partial sectional view representing the state where the second disk substrate 3 is held by a holding part 65 of the second disk substrate loading arm 63, and joined to the first disk substrate 2 on the base 71. The second disk substrate loading arm 63 shown in FIG. 9 has a configuration that enables transport of the second disk substrate 3 to the base 71, and also transport of the first disk substrate 2 and second disk substrate 3 joined on the base 71 to the second rotating device 81 (see FIG. 7) from the base 71. Thus, transport of the first disk substrate 2 and second disk substrate 3 from the base 71 to the second rotating device 81 (see FIG. 7) may be conducted by the second disk substrate loading arm 63 rather than the third moving means 83 (see FIG. 7). The second disk substrate loading arm 63 is provided with the holding part 65 that hangs down from the arm 64. The holding part 65 is provided with an adhesion head 67 in which an adhesion port 68 is formed for adhesion to and retention of the second disk substrate 3, a claw 69 for mechanically holding the first disk substrate 2, and an air cylinder 66 for opening and closing the claw 69. The base 71 is provided with a disk rest 75 for supporting the first disk substrate 2, and a dividable projection 73 for engaging with the aperture 6 (see FIG. 1) for purposes of positioning the first disk substrate 2. A notch 74 for insertion of the claw 69 is formed by opening the projection 73.

In the state shown in FIG. 9, the first disk substrate 2 provided with the second resin 9 is supported by the disk rest 75, and the base 71 further holds the first disk substrate 2 by the adhesion and suction of a suction port provided in the disk rest 75. The projection 73 is divided and open, firmly holding the aperture 6 of the first disk substrate 2 (see FIG. 1). That is, the notch 74 is formed. The holding part 65 also holds the second disk substrate 3 by the adhesion head 67. In addition, the claw 69 is in a contracted state. From the state shown in FIG. 9, the disk rest 75 is raised, and stops after the second resin 9 contacts the second disk substrate 3. At that time, the claw 69 is inserted into the aperture 6 of the first disk substrate 2, and enters into the notch 74. By opening the claw 69, the first disk substrate 2 is held from the aperture 6 side. When the suction of the disk rest 75 is stopped, and the adhesive retention of the first disk substrate ceases, the disk rest 75 is lowered. Next, the joined first disk substrate 2 and second disk substrate 3 are moved by swiveling the arm 64.

In the case of a configuration where, as with the optical disk manufacturing apparatus 32, first disk substrate 2 and second disk substrate 3 joined on the base 71 are moved from the base 71 to the second rotating device 81 (see FIG. 7) by the third moving means 83 (see FIG. 7), and where movement by the second disk substrate loading arm 63 is limited to moving the second disk substrate 3 onto the base 71, the claw 69 is omitted, and the suction of the adhesion head 67 is stopped after the second resin 9 on the first disk substrate 2 contacts and is joined to the second disk substrate 3, and the disk rest 75 is lowered in a state where the first disk substrate 2 and second disk substrate 3 are mounted on the disk rest 75. In the case where the claw 69 is omitted, the projection 73 does not divide, and may be fixed. In addition, as shown in FIG. 3, the infiltration of air bubbles can be prevented when joining is conducted while applying alternating-current or direct-current voltage between the first disk substrate 2 and second disk substrate 3, and this is preferable.

With the optical disk manufacturing apparatus, the quantity of optical disks manufactured per unit time is increased by conducting each processing in parallel. Moreover, as each processing is conducted by respectively dedicated devices, the structures of the respective devices are simple, and control is simple. As a result, the reliability of the entire apparatus is improved. Even if the first resin 8 and second resin 9 are of different material, treatment is easy.

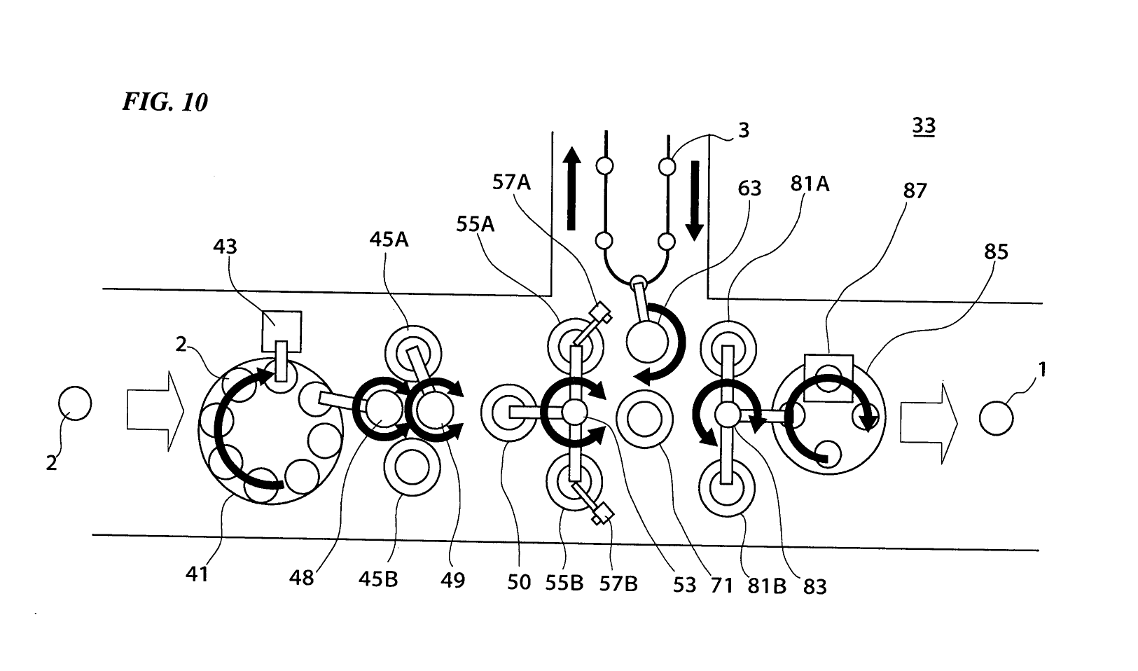

As shown in FIG. 10, by respectively providing two units pertaining to a first rotating device 45A and 45B, a second resin supply device 57A and 57B, and a second rotating device 81A and 81B for conducting the time-consuming processing, it is possible to greatly improve the optical disk manufacturing volume per unit time. That is, by conducting the time-consuming processing in parallel with two units, work efficiency is improved approximately two-fold even if the other devices remain at one unit. Based on the circumstances of the lay-out of the various devices, instead of the first moving means 47 (see FIG. 7), an optical disk manufacturing apparatus 33 shown in FIG. 10 is provided with a first-A moving means 48 for moving the first disk substrate 2 from the first turntable 41 to the first rotating device 45A and 45B, and a first-B moving means 49 for moving it from the first rotating device 45A and 45B to the first ultraviolet irradiation device 50, but it is also acceptable to provide the first moving means 47 (see FIG. 7). As the remaining configuration is identical to that of the optical disk manufacturing apparatus 32 (see FIG. 7), duplicative description is omitted.

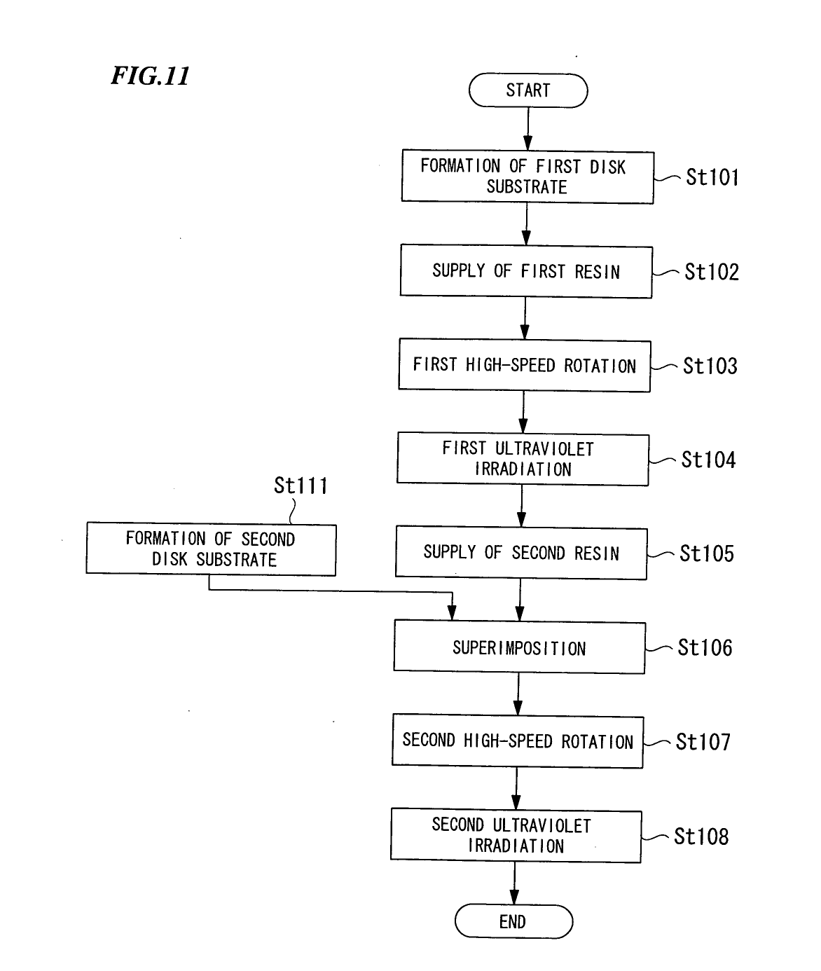

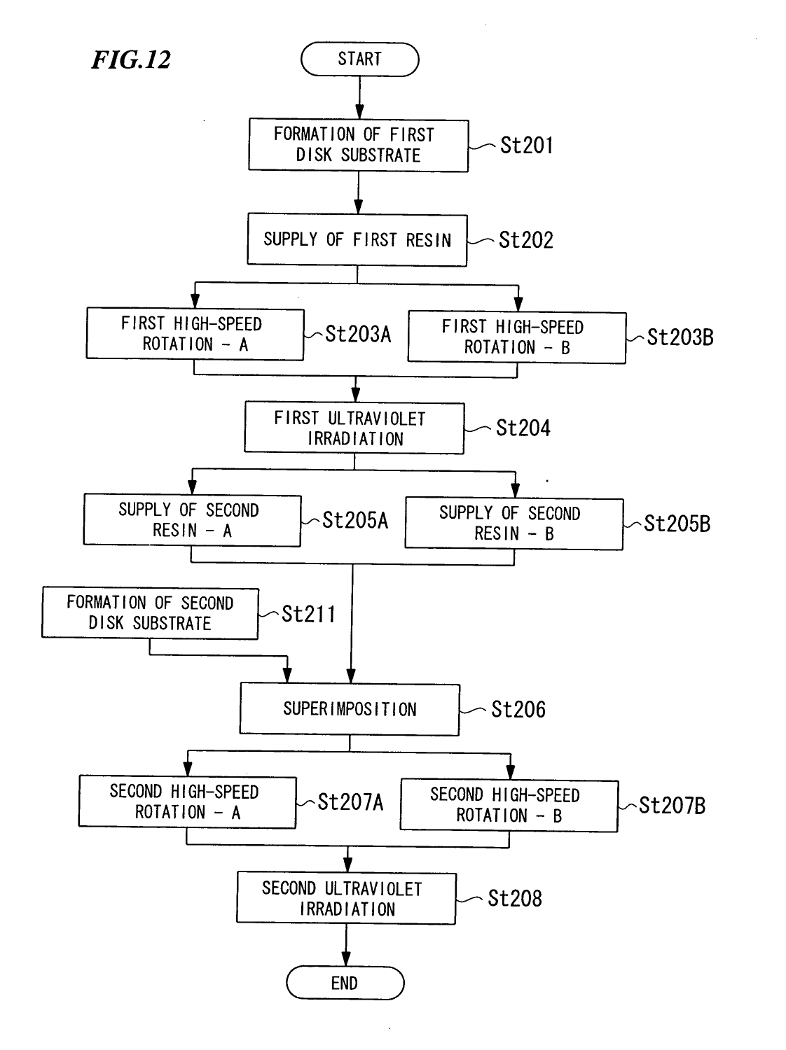

The manufacturing method of an optical disk processed in a single series, and the manufacturing method of an optical disk for which parallel processing is conducted for a portion of the processing are here described with reference to the flowcharts shown in FIG. 11 and FIG. 12. FIG. 11 is a flowchart presenting the manufacturing method of an optical disk of a single series, and FIG. 12 is a flowchart presenting the manufacturing method of an optical disk that undergoes parallel processing in part. In the processing pertaining to FIG. 11, code numbers added to 100 are used, and in the case of the parallel processing, “A” and “B” are affixed to the end of the code numbers. That is, the code number for the first high-speed rotation in FIG. 11 is St103, and the code numbers of the first high-speed rotation in FIG. 12 are St203A and St203B.

As shown in the flowchart of FIG. 11, first, a first disk substrate is molded with an aperture at the center (St101). Next, the first resin is supplied to the first disk substrate. The resin is toroidally supplied in the region adjacent to the perimeter of the aperture (St102). Next, the toroidally supplied resin is spread to the prescribed thickness by conducting a first rotation of the first disk substrate at high speed (St103). When the resin has spread to the prescribed thickness, the surrounding vicinity of the aperture is irradiated by ultraviolet rays, and the resin in the surrounding vicinity of the aperture is cured (St104). As stated above, it is also acceptable to use a resin other than ultraviolet-curing resin, and to cure the resin by a method other than ultraviolet irradiation. Next, resin is toroidally supplied to the region adjacent to the perimeter of the aperture from above the spread and partially cured resin (St105).

A second disk substrate is molded separately from the processing conducted to this point, and in parallel with the processing conducted to this point (St111). The second disk substrate has the same form as the first disk substrate molded in ST101, but the recorded data is different.

The second disk substrate formed in ST111 is then superimposed on the first disk substrate provided with resin in St105 on the side provided with resin (St106). Next, the resin that has been narrowed in between is spread to the prescribed thickness by high-speed rotation of the second disk substrate (St107). When the prescribed thickness is reached, the entirety of the resin is irradiated by ultraviolet rays and cured, thereby joining together the two disk substrates (St108). This is the manufacturing method of an optical disk processed in a single series.

In the optical disk manufacturing method shown in FIG. 12, the aforementioned first high-speed rotation of St103, the second resin supply of St105, and the second high-speed rotation of St107 are conducted with parallel processing. That is, parallel processing is conducted for the time-consuming operation St203A/B wherein the first disk substrate is rotated at high speed and the resin is spread, operation ST205A/B wherein resin is toroidally supplied on top of the spread and cured resin, and operation St207A/B wherein the first disk substrate and second disk substrate are rotated at high speed and the resin is spread. By conducting parallel processing of the time-consuming operations, the same effect can be obtained even if all operations are not conducted in parallel, and processing capacity is greatly increased. Particularly with regard to the operations that require much processing time, processing capacity can be further improved by having three series or four series, rather than two series. Which processing operation is to be conducted in parallel depends upon the time required for processing, and one is not limited to the example shown in FIG. 12. It is also acceptable to parallelize the other processing operations, or to conduct in a single series the operations St203A/B and St207A/B that rotate the disk substrates at high speed and spread the resin, or operation St205A/B that toroidally supplies resin on top of the spread and cured resin, and conduct the other operation(s) in parallel.

Description to this point has pertained to an optical disk where resin is supplied only to a single disk substrate, another disk substrate is superimposed from above, and the two disk substrates are joined together, but it is also acceptable to manufacture the optical disk by supplying resin to each of the disk substrates, and then joining the two disk substrates.

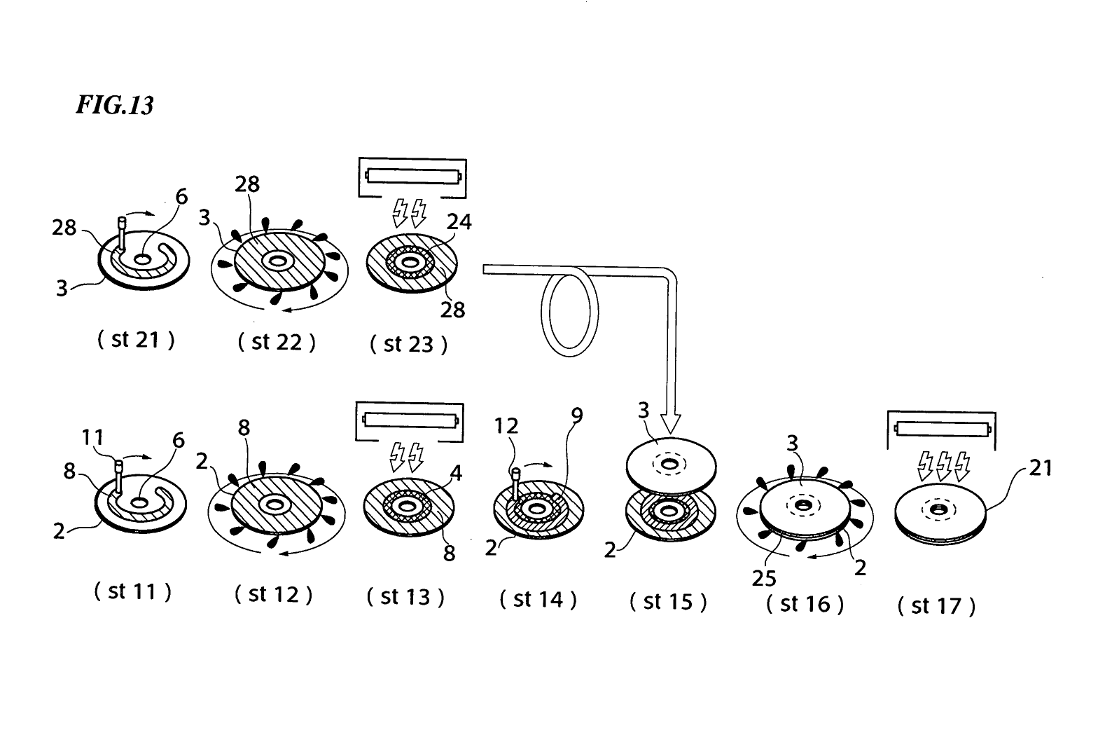

FIG. 13 shows an example of a process drawing of optical disk manufacturing where resin is supplied to two disk substrates, which are then joined together. That is, the operations where the first resin 8 is supplied to the first disk substrate 2 (St11), the first resin 8 is spread by rotation (St12), the first resin 8 in the surrounding vicinity of the aperture 6 is cured (ST13), and the second resin 9 is supplied to the region adjacent to the perimeter of the aperture 6 (St14) are identical to the operations shown in FIG. 2. On the other hand, a first-B resin 28 is toroidally supplied to the second disk substrate 3 as well, in the region adjacent to the perimeter of the aperture 6 (St21), is spread to the prescribed thickness by high-speed rotation (St22), and a first-B resin 24 is cured in the surrounding vicinity of the aperture 6 (St23). The second disk substrate 3 is then vertically inverted, and superimposed on the first disk substrate 2 (St15). That is, the first-B resin 28 is superimposed on the second resin 9. Next, the two disk substrates 2 and 3 are rotated at high speed, the resin 25 (including the not-cured first resin 8 in the second resin 9 and the first-B resin 28) is spread until the prescribed thickness is reached (St16), and the entire resin 25 is cured (St17), whereby the two disk substrates 2 and 3 are joined together, and the optical disk 21 is manufactured.

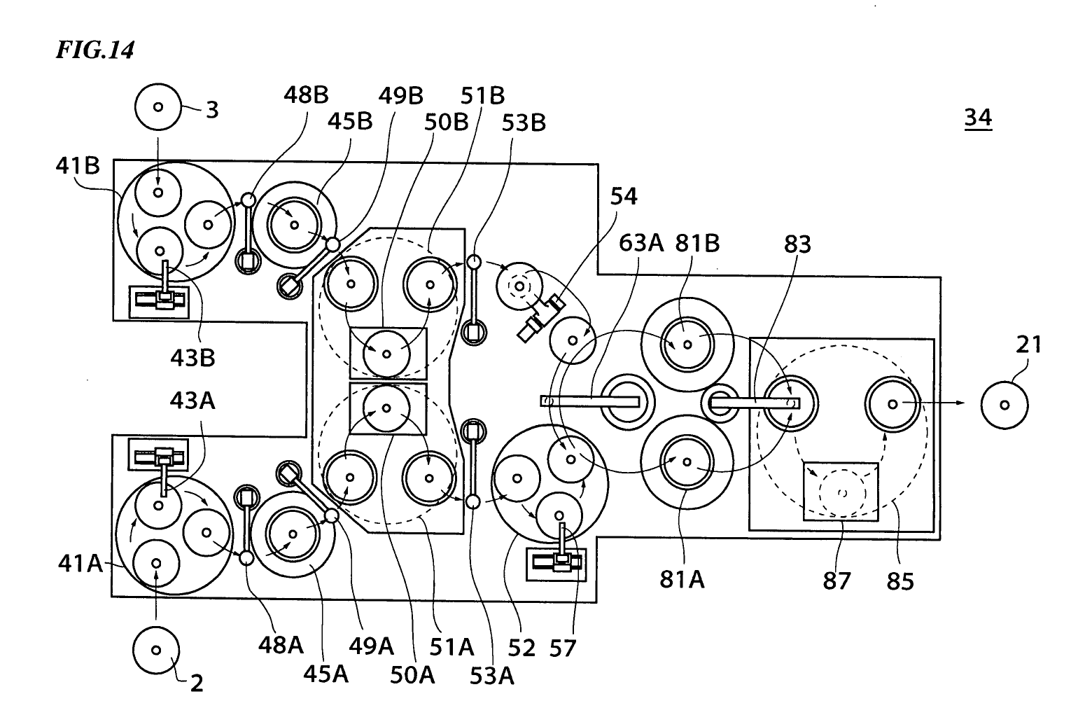

An optical disk manufacturing apparatus 34 for manufacturing an optical disk 21 is described with reference to FIG. 14, and also with reference to FIG. 13 as appropriate. FIG. 14 is a block diagram presenting the configuration of the optical disk manufacturing apparatus 34, which is one example of the manufacturing apparatus for manufacturing the optical disk 21 where resin is supplied to two disk substrates which are then joined together. Only the points which differ from the optical disk manufacturing apparatuses 31 to 33 shown in FIG. 5, FIG. 7 and FIG. 11 are described, and duplicative description is omitted. In the description of FIG. 5, FIG. 7 or FIG. 11, whatever has “A” or “B” affixed as a suffix to the code number is basically identical to the devices described with code numbers devoid of suffixes.

In contrast to optical disk manufacturing apparatuses 31 to 33, the optical disk manufacturing apparatus 34 is composed of a turntable 41B for rotationally moving the second disk substrate 3, a first-B resin supply device 43B for supplying the first-B resin 28 to the second disk substrate 3, a third rotating device 45B for conducting high-speed rotation of the second disk substrate 3, and for spreading the first-B resin 28, a third ultraviolet irradiation device 50B for curing the first-B resin 24 in the surrounding vicinity of the aperture 6 of the second disk substrate 3 on which the first-B resin 28 has been spread, and a disk substrate inversion device 54 for vertically inverting the second disk substrate 3 on which the first-B resin 24 surrounding the aperture 6 has cured. In addition, it is also provided with the aforementioned moving means 48B, 49B and 53B for moving the disk substrate 3 among the various devices.

The second disk substrate 3 is supplied to the turntable 41B, and the first-B resin supply device 43B there toroidally supplies the first-B resin 28 to one side in the region adjacent to the perimeter of the aperture 6. The first-B resin 28 typically uses the same resin as the first resin 8, but it does not have to be the same. The second substrate 3 provided with the first-B resin 28 is mounted on the disk mount of the third rotating device 45B by the first-A moving means 48B. There, the first-B resin 28 is spread over the surface of the second substrate 3 by high-speed rotation. When the first-B resin 28 has spread and has reached the prescribed thickness, the third rotating device 45B ceases to rotate. The rotational speed and the like of the third rotating device 45B are basically identical to those of the first rotating device 45A. However, their respective rotational speeds and rotation times do not have to be identical.

When the first-B resin 28 is spread, the second disk substrate 3 is sent to the third ultraviolet supply device 50B, where the first-B resin 24 in the surrounding vicinity of the aperture 6 is irradiated by ultraviolet rays. The first-B resin 24 irradiated by ultraviolet rays is cured. It is also acceptable if it does not completely cured, and remains in a semi-cured state like a gel. When the first-B resin in the surrounding vicinity of the aperture 6 is cured, the second disk substrate 3 is sent to the disk substrate inversion device 54 by the turntable 51B and the second moving means 53B. In the disk substrate inversion device 54, the second disk substrate 3 is placed on a support stand supported by a horizontally extended column, the column is turned 180 degrees vertically from above still in the horizontal direction, and the second disk substrate 3 on the support stand is vertically inverted.

The vertically inverted second disk substrate 3 is superimposed onto the first disk substrate 2 provided with the second resin 9 atop the turntable 52. The first resin 8 is formed on the first disk substrate 2, and the second resin 9 is further provided on it, while the first-B resin 28 is formed on the bottom surface of the second disk substrate 3. Consequently, the resin layers of the two disk substrates 2 and 3 are mutually overlaid by superimposing the second disk substrate 3 onto the first disk substrate 2. When the two disk substrates 2 and 3 are laid one atop the other, high-speed rotation is conducted by the second rotating device 81A and B, spreading occurs until the prescribed thickness is reached, the entirety of the resin 25 (including the not-cured first resin 8 in the second resin 9 and the first-B resin 28) is cured by the second ultraviolet irradiation device 87, and the optical disk 21 is manufactured by the joining of the two disk substrates 2 and 3.

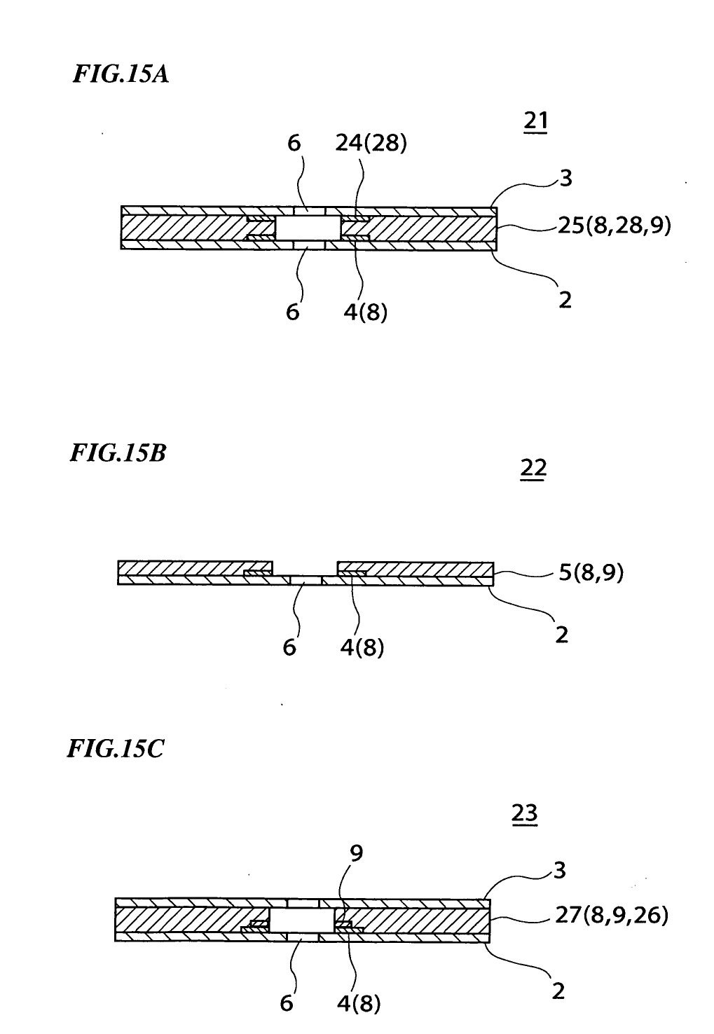

FIG. 15A shows one example of a sectional view of the optical disk 21. In the optical disk 21, the first resin 4 and the first-B resin 24 cured in the surrounding vicinity of the aperture 6 are formed, after which the second resin 9 is provided, and the resin 25 (including the not-cured first resin 8 in the second resin 9 and the first-B resin 28) is spread by high-speed rotation. The resin 25 thins on the inner circumferential side and thickens on the outer circumferential side as a result of the high-speed rotation, but as there exists the previously cured first resin 4 and first-B resin 24 in the surrounding vicinity of the aperture 6—that is, on the inner circumferential side—a resin layer (adhesive layer) of uniform thickness results. In particular, as a cured first resin 4 and first-B resin 24 are formed on the two disk substrates 2 and 3, it is possible to thickly form the pre-cured resin layers. Moreover, as a cured resin layer that is collectively thick is obtained even if the first resin 8 and first-B resin 28 are thinly spread, the control of thickness by the spread of the first resin 8 and first-B resin 28 is facilitated, and accuracy is made easy. In addition, as the second resin 9 can be used with the objective of connecting the first disk substrate 2 and second disk substrate 3, it is possible to obtain an optical disk substrate 21 where air bubbles do not exist by conducting high-speed rotation regardless of the post-spreading film thickness.

The foregoing descriptions have concerned an optical disk manufacturing method and apparatus where the second resin 9 narrowed between the first disk substrate 2 and second disk substrate 3 is spread, and a resin layer of uniform thickness is formed, but it is also acceptable to configure the optical disk from a single disk substrate.

FIG. 15B shows one example of a sectional view of an optical disk 22 composed of a single disk substrate 2. In the optical disk 22, a first resin 8 is toroidally supplied on the first disk substrate 2 in the region adjacent to the aperture 6 and spread by high-speed rotation, and the resin 4 in the surrounding vicinity of the aperture 6 is cured. Next, the second resin 9 is toroidally supplied to the region adjacent to the aperture 6, and high-speed rotation is conducted in that state. When this is done, the resin 5 of uniform thickness is formed on the first disk substrate 2 by the first resin 8 and second resin 9. That is, if a signal layer or recording layer is formed on the top surface of the first disk substrate 2, the first resin 8 and second resin 9 constitute a protective layer of the signal layer or recording layer, and the optical disk 22 composed of a single disk substrate 2 is made. As the thickness of the protective layer is uniform, errors in reading the recorded data are prevented.

The foregoing description has involved partial curing of a first resin, and supply of a second resin, after which the entire resin is cured, but it is also acceptable to do as follows in order to make the thickness of the adhesive layer or resin layer uniform.

For example, as shown in FIG. 15C, it is acceptable to partially cure the inner circumferential part of the first resin 4, to also partially cure the inner circumferential part of the second resin 9 in a different range than the first resin 4, and then supply a third resin 26, and spread it by high-speed rotation to form a resin layer 27. Furthermore, it is also acceptable to form multiple layers from the partially cured inner circumferential parts of a third resin, fourth resin, etc. Stated differently, in the optical disk manufacturing process presented in FIG. 2, it is acceptable to conduct a plurality of repetitions of the toroidal supply of the first resin in St1, the spreading of the first resin in St2, and the curing of the first resin in St3. In this case, the amount of first resin that is supplied and the position of supply may be identical, or may differ. By repeating the supply, spreading and curing of the resin in this manner, it is possible to minutely adjust the distribution of thickness, and an adhesive layer or resin layer of more uniform thickness is obtained.

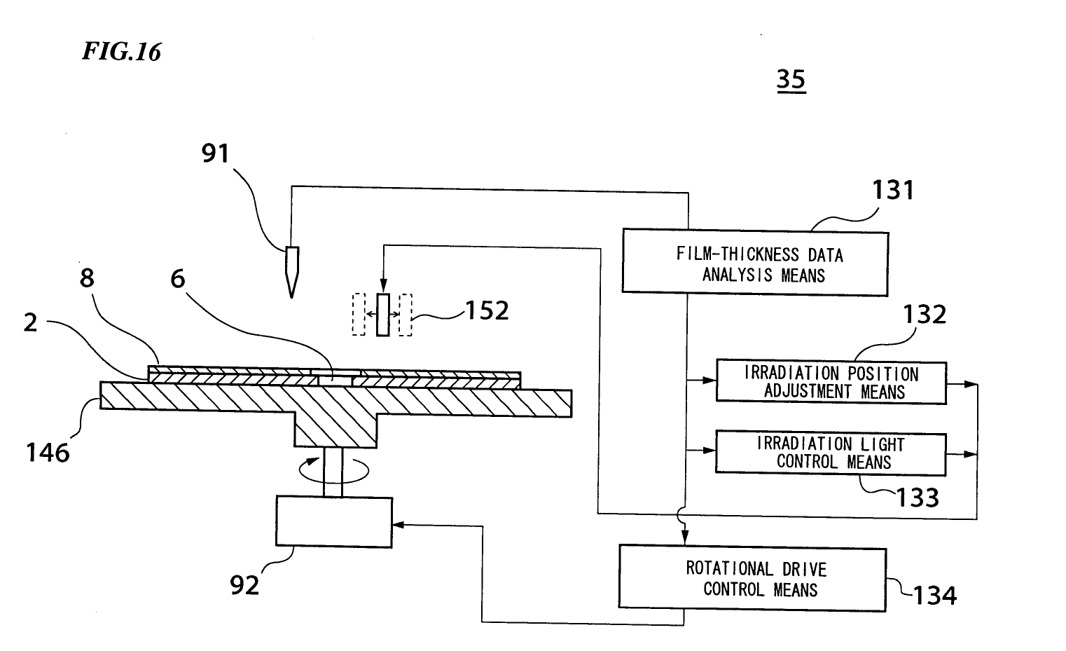

FIG. 16 is an embodiment of another resin-curing device 35 that irradiates the first resin 8 in the surrounding vicinity of the aperture 6 of the first disk substrate 2 with ultraviolet rays, and cures the first resin 8. A film-thickness measurement means 91 measures the film thickness of the first resin 8, and a film-thickness data analysis means 131 collects the film thickness data of the first resin 8, and conducts analysis. The film-thickness measurement means 91 is, for example, a non-contact film measurement device using a laser beam, and measures the film thickness of the first resin 8 during spreading by rotation or before curing in the surrounding vicinity of the aperture 6 after spreading. The measured film thickness is sent to the film-thickness data analysis means 131.

Based on the film thickness data collected by the film-thickness data analysis means 131, an irradiation position adjustment means 132 minutely adjusts the position of a spot ultraviolet irradiation device 152. For example, the film thickness of the first resin at a certain position in the surrounding vicinity of the aperture 6 during spreading is measured by the film-thickness measurement means 91, and the first resin 8 at that position is cured when film thickness reaches the prescribed value. By this means, the film thickness at each position can be adjusted to the prescribed thickness. Accordingly, even if the thickness distribution of the first resin 8 in the vicinity of the central aperture 6 varies due to variations in temperature and humidity inside the device 35, variations in resin viscosity, variations in molding conditions and the like, it is possible to adjust the curing position of the first resin 8 in the surrounding vicinity of the aperture 6 of the first disk substrate 2, and overall film thickness can ultimately be uniformly controlled.

Alternatively, based on the film thickness data from the film-thickness data analysis means 131, an irradiation light control means 133 is able to adjust the state of curing from semi-curing to complete curing of the first resin 8 in the surrounding vicinity of the aperture 6 of the first disk substrate 2, and ultimately to uniformly control overall film thickness by adjusting the irradiation intensity and irradiation time of the irradiation light. That is, in the case where spreading has occurred up to the prescribed thickness by high-speed rotation, the irradiation light control means 133 increases the irradiation intensity and irradiation time of the irradiation light, and fully cures the first resin 8. In the case where thickness exceeds the prescribed thickness, it is possible to decrease the irradiation intensity and irradiation time of the irradiation light, weaken the degree of curing of the first resin 8 to a gel-like state, and conduct a smaller spread in the subsequent second high-speed rotation.

Alternatively, based on the film thickness data from the film-thickness data analysis means 131, a rotational drive control means 134 is able to produce an appropriate film thickness of the first resin 8 in the surrounding vicinity of the aperture 6 of the first disk substrate 2, and ultimately to uniformly control overall film thickness by regulating the rotational speed of a rotational drive device 92 of the disk-rotating device 145 (see FIG. 2), and by adjusting the rotational speed of the first disk substrate 2 mounted on the disk mount 146 connected to the rotational drive device 92. That is, when it is desired to more thinly spread the first resin 8, the rotational speed of the rotational drive device 92—that is, of the first disk substrate 2—is increased by the rotational drive control means 134, and when it is no longer necessary to more thinly spread it, the rotational speed of the rotational drive device 92—that is, of the first disk substrate 2—is decreased by the rotational drive control means 134.

As described above, it is possible to minutely adjust film thickness and obtain an adhesive layer or resin layer of more uniform thickness by adjusting the curing of the first resin 8 by the irradiation position adjustment means 132 or the irradiation light control means 133, or by controlling the rotational drive device 92 by the rotational drive control means 134. If any one of the irradiation position adjustment means 132 or irradiation light control means 133 or rotational drive control means 134 is provided, it is possible to minutely adjust the film thickness of the first resin 8—that is, of the cured first resin 4 (see FIG. 1)—but still more minute adjustment is possible by combining these. It is acceptable to have the film-thickness data analysis means 131 output control signals to the irradiation position adjustment means 132 or irradiation light control means 133 or rotational drive control means 134 according to each piece of film-thickness data pertaining to the first resin 8 that is sequentially outputted from the film-thickness measurement means 91. By obtaining average values for the film thickness data of the first resin 8 tabulated from, for example, several tens or several hundreds of units, and outputting control signals to the irradiation position adjustment means 132 or irradiation light control means 133 or rotational drive control means 134, it is possible to conduct a more uniform film-thickness control that is not affected by sudden fluctuations in film thickness. Moreover, these types of devices and means can be effectively employed in any of the optical disk manufacturing apparatuses pertaining to the present invention.

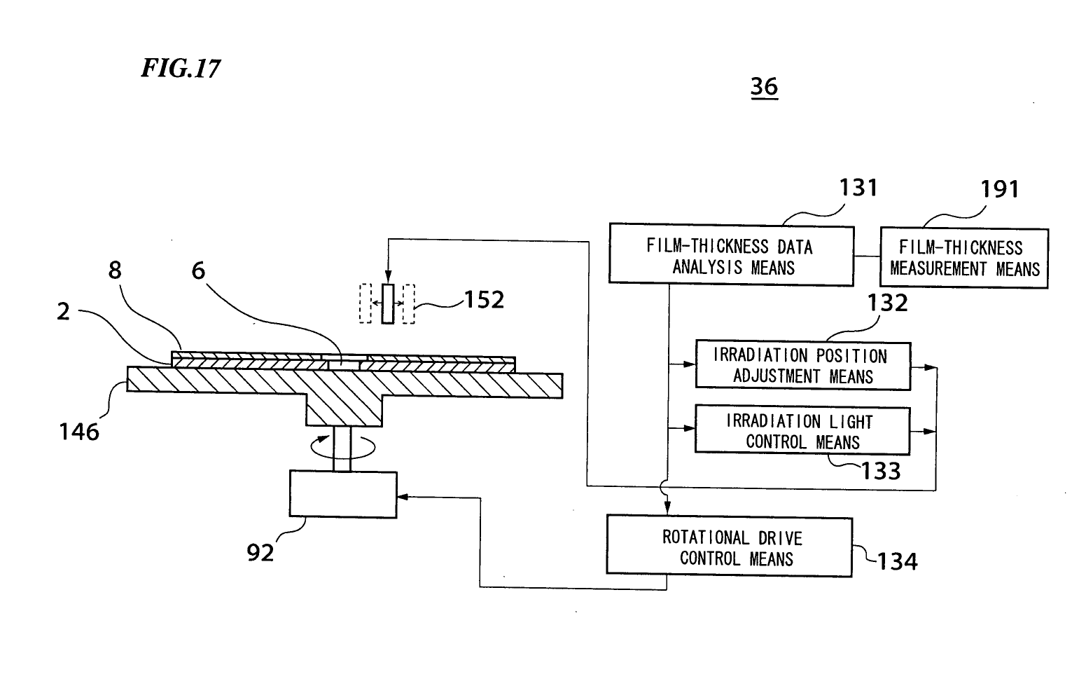

FIG. 17 is an embodiment of another resin-curing device 36 that irradiates the first resin 8 in the surrounding vicinity of the aperture 6 of the first disk substrate 2 by ultraviolet rays, and cures the first resin 8. In contrast to the resin-curing device 35, the film-thickness measurement means 191 is provided separately from the resin-curing device 36 as, for example, in an inspection device for the manufactured optical disks. The film thicknesses measured by the film-thickness measurement means 191 are sent to the film-thickness data analysis means 131. the film-thickness data analysis means 131 collects the film thickness data, and conducts analysis. Based on the film thickness data collected by the film-thickness data analysis means 131, as with the resin-curing device 35, the state of curing of the first resin 8 is adjusted by the irradiation position adjustment means 132 or irradiation light control means 133, or the rotational drive device 92 is controlled by the rotational drive control means 134. As a result, minute adjustment of film thickness is possible, and an adhesive layer or resin layer of more uniform film thickness is obtained. If any one of the irradiation position adjustment means 132 or irradiation light control means 133 or rotational drive control means 134 is provided, it is possible to minutely adjust the film thickness of the first resin 8—that is, of the cured first resin 4 (see FIG. 1)—but still more minute adjustment is possible by combining these. It is acceptable to have the film-thickness data analysis means 131 output control signals to the irradiation position adjustment means 132 or irradiation light control means 133 or rotational drive control means 134 according to each piece of film-thickness data that is sequentially outputted from the film-thickness measurement means 191. By collecting the film thickness data, obtaining average values for the film thickness data tabulated from, for example, several tens or several hundreds of units, and outputting control signals to the irradiation position adjustment means 132 or irradiation light control means 133 or rotational drive control means 134, it is possible to conduct a more uniform film-thickness control that is not affected by sudden fluctuations in film thickness. Moreover, these types of devices and means can be effectively employed in any of the optical disk manufacturing apparatuses pertaining to the present invention.

In FIG. 1, in order to facilitate understanding, the thickness of the resin layer 5 is represented larger than the first disk substrate 2 and second disk substrate 3, but ordinarily, in contrast, the thickness of the first disk substrate 2 and second disk substrate 3 is frequently larger than the thickness of the resin layer 5. The same applies to the other drawings.

In FIG. 1, the cured first resin 4 is represented as a rectangular region in order to facilitate understanding, but it is also acceptable to have a curved shape that is suited to correcting the thickness of the second resin 9. The same applies to the other drawings.

In FIG. 1, the first resin 4 is arranged so as to completely cover the second resin 5, but it is also acceptable to have a portion of the resin 4 contact the disk substrate 3 without completely covering the resin 5. The same applies to the other drawings.

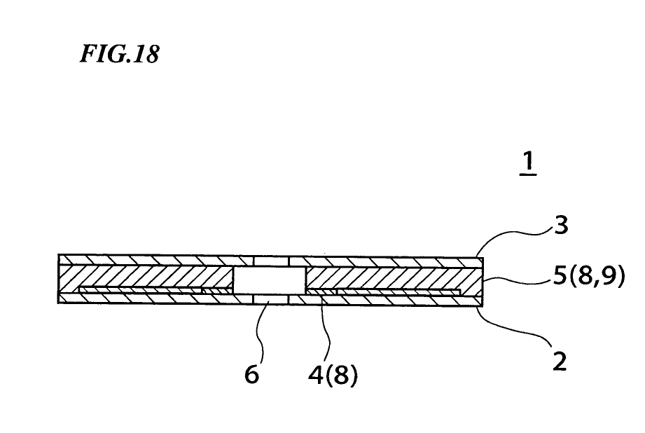

In FIG. 2 (St3), which is a process drawing, after extending the first resin 8 that is spread on the surrounding vicinity of the aperture, upon curing or semi-curing the first resin 4 by irradiation with ultraviolet rays on the first resin 8 at the vicinity of the aperture, resin from outside the vicinity of the aperture to the vicinity of the rim may be semi-cured along with forming of the first resin 4. The method of irradiation is such that, for example, using an ultraviolet irradiation device 150 as shown in FIG. 6A and FIG. 6B, after forming the first resin around the aperture, a range of irradiation is extended to the vicinity of the rim and resin from outside of the first resin 4 to the vicinity of the rim is semi-cured. That is, as shown in FIG. 18, which is a sectional view, in the first resin 8 which has been extended, a state can be achieved in which resin from outside of the first resin 4 to the vicinity of the rim is semi-cured. By semi-curing resin from outside of the first resin 4 to the vicinity of the rim in the above described manner, it is possible to adjust the thickness of the resin film not only in the vicinity of the aperture, but also in the vicinity of the rim, and therefore, it is possible to produce a resin layer which has entirely uniform thickness.

In FIG. 2, the first resin nozzle 11 and second resin nozzle 12 may be in approximately the same position. In FIG. 2, the first resin nozzle 11 and second resin nozzle 12 may be identical. In step St3 of FIG. 2, the ultraviolet irradiation time may be appropriately varied according to the easiness of curing of the resin 4. For example, irradiation time may be shortened for resins with higher easiness of curing, and irradiation time may be lengthened for resins with lower easiness of curing.

In FIG. 3B, it is acceptable if the first resin 8 in the vicinity of the center of the first disk substrate 2 is at least in a semi-cured state—that is, like a gel—so that it does not run off even when the first disk substrate 2 is rotated. It is also acceptable if the thickness of the first resin 8 in the vicinity of the rim of the first disk substrate 2 is larger than that in the vicinity of the center, as represented in FIG. 4. In addition, in FIG. 3C, the second disk substrate 3 may be held by methods such as suction and clutch.

The optical disk manufacturing method includes a process of toroidally supplying a first resin on one side of a first disk substrate having an aperture at the center in a region adjacent to the perimeter of the aperture, a process of rotating the first disk substrate provided with the first resin at a first rotational speed, and spreading the first resin, a process of curing the spread first resin in the surrounding vicinity of the aperture, a process of toroidally supplying a second resin that is superimposed on the first resin of the first disk substrate on which the first resin has cured, in the region adjacent to the perimeter of the aperture, a process of rotating the first disk substrate provided with the second resin at a second rotational speed, and spreading the second resin, and a process of curing the spread second resin, with the result that an optical disk manufacturing method is obtained that cures the first resin in the surrounding vicinity of the aperture, that supplies the second resin, and cures it after spreading it by high-speed rotation, and that forms a resin layer of uniform thickness by the first resin and the second resin.

The optical disk manufacturing apparatus includes a first resin supply device for toroidally supplying a first resin on one side of a first disk substrate having an aperture at the center, in a region adjacent to the perimeter of the aperture, a disk-rotating device for rotating the first disk substrate, a first resin-curing device for curing the first resin in the surrounding vicinity of the aperture, a second resin supply device for toroidally supplying a second resin on one side of the first disk substrate on which the first resin has cured, in the region adjacent to the perimeter of the aperture, and a second resin-curing device for curing the second resin, with the result that an optical disk manufacturing apparatus is obtained that cures the first resin in the surrounding vicinity of the aperture, that supplies and rotates the second resin, and cures the second resin, and that forms a resin layer of uniform thickness by the first resin and the second resin.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An optical disk manufacturing method comprising the steps of:
toroidally supplying a first resin on one side of a first disk substrate having an aperture at a center, in a region adjacent to a perimeter of said aperture;
rotating the first disk substrate provided with said first resin at a first rotational speed, and spreading said first resin;
curing said spread first resin in a surrounding vicinity of said aperture;
toroidally supplying a second resin that is superimposed onto said first resin of the first disk substrate on which said first resin has cured, in the region adjacent to the perimeter of said aperture;
rotating the first disk substrate provided with said second resin at a second rotational speed, and spreading said second resin; and
curing said spread second resin.

2. The optical disk manufacturing method according to claim 1, further comprising the step of:
superimposing a second disk substrate concentric with said first disk substrate onto said second resin provided on said first disk substrate.

3. The optical disk manufacturing method according to claim 1, wherein
said first resin and said second resin are ultraviolet-curing resin.

4. The optical disk manufacturing method according to claim 1, wherein
said spread second resin is formed more thickly than said cured first resin.

5. The optical disk manufacturing method according to claim 1, wherein
said first rotational speed is greater than said second rotational speed.

6. The optical disk manufacturing method according to claim 1, wherein
the steps of supplying said first resin, spreading said first resin, and curing said spread first resin are repeated two or more times.

7. An optical disk manufacturing apparatus comprising:
a first resin supply device for toroidally supplying a first resin on one side of a first disk substrate having an aperture at a center, in a region adjacent to a perimeter of said aperture;
a disk-rotating device for rotating said first disk substrate;
a first resin-curing device for curing said first resin in a surrounding vicinity of said aperture;
a second resin supply device for toroidally supplying a second resin on one side of the first disk substrate on which said first resin has cured, in a region adjacent to a perimeter of said aperture; and
a second resin-curing device for curing said second resin.

8. The optical disk manufacturing apparatus according to claim 7, further comprising:
a disk substrate supply device for superimposing a second disk substrate concentric with said first disk substrate onto the second resin provided on said first disk substrate.

9. The optical disk manufacturing apparatus according to claim 7, wherein
said first resin supply device and said second resin supply device are the same device.

10. The optical disk manufacturing apparatus according to claim 7, wherein
said disk-rotating device rotates at greater rotational speed during a period after said first resin is supplied until curing occurs by said first resin-curing device than after said second resin is supplied.

11. The optical disk manufacturing apparatus according to claim 7, further comprising a control device for controlling:
supplying said first resin to said first disk substrate;
rotating the first disk substrate provided with said first resin at a first rotational speed;
curing said first resin of the first disk substrate rotated at said first rotational speed by a first resin-curing device;
supplying said second resin to the first disk substrate on which said first resin has cured;
rotating the first disk substrate provided with said second resin at a second rotational speed; and
curing the second resin of the first disk substrate rotated at said second rotational speed by a second resin-curing device.

12. The optical disk manufacturing apparatus according to claim 7, wherein:
said first resin-curing device comprises a film-thickness measurement unit for measuring the film thickness of said first resin on said first disk substrate and
a unit for adjusting the film thickness of said first resin based on the film thickness measured by said film-thickness measurement unit.

13. An optical disk manufacturing apparatus comprising:
a first resin supply device for toroidally supplying a first resin on one side of a disk substrate having an aperture at a center, in a region adjacent to a perimeter of said aperture;
a first disk-rotating device for rotating said disk substrate;
a first resin-curing device for curing said first resin in a surrounding vicinity of said aperture;
a second resin supply device for toroidally supplying a second resin on one side of the disk substrate on which said first resin has been cured, in a region adjacent to a perimeter of said aperture;
a second disk-rotating device for rotating the disk substrate provided with said second resin;
a disk transportation device for transporting said disk substrate from said first disk-rotating device to said second disk-rotating device; and
a second resin-curing device for curing the second resin of the disk substrate rotated by said second disk-rotating device.

14. An optical disk comprising:
a toroidal first layer positioned in a region near a center of a disk substrate on one side of the pertinent disk substrate; and
a second layer overlaying at least part of said first layer, and covering the recording surface on said one side,
wherein said first layer is formed to become at least semi-cured before said second layer is cured.
